(19) United States
(12) Patent Application Publication
(10) Pub. No.: US 2022/0284171 A1
(43) Pub. Date: Sep. 8, 2022

(54) HIERARCHICAL STRUCTURE LEARNING WITH CONTEXT ATTENTION FROM MULTI-TURN NATURAL LANGUAGE CONVERSATIONS

(71) Applicants: SRIVATSAN LAXMAN, palo alto, CA (US); SUPRIYA RAO, PALO ALTO, CA (US); SRIKHAR PADMANABHAN, PALO ALTO, CA (US)

(72) Inventors: SRIVATSAN LAXMAN, palo alto, CA (US); SUPRIYA RAO, PALO ALTO, CA (US); SRIKHAR PADMANABHAN, PALO ALTO, CA (US)

(21) Appl. No.: 17/693,414

(22) Filed: Mar. 14, 2022

Related U.S. Application Data
(63) Continuation-in-part of application No. 16/917,882, filed on Jun. 30, 2020, now abandoned.
(60) Provisional application No. 63/246,317, filed on Sep. 21, 2021.
(60) Provisional application No. 62/869,160, filed on Jul. 1, 2019.

(51) Int. Cl. G06F 40/117; G06F 40/242; G06F 40/268; G06F 40/205; G06F 40/35; G06F 40/284; G06N 3/04

(52) U.S. Cl. CPC G06F 40/117; G06F 40/242; G06F 40/268; G06F 40/205; G06F 40/35; G06F 40/284; G06N 3/04

(57) ABSTRACT

A computerized method for implementing a neural architecture for hierarchical sequence labelling comprising: providing a neural architecture comprising a set of labelling layers, wherein the neural architecture uses a multi-pass approach on the set of labelling layers, receiving an input sentence; parsing the input sentence; embedding the input sentence into a corresponding character vector and a corresponding word vector to generate a feature vector; passing the feature vector through the neural architecture; and performing a multi-layer labelling procedure on the feature vector with the neural architecture comprising: augmenting a set of corresponding bits of the feature vector, wherein the feature vector is passed through the set of labelling layers of neural architecture.

### CLAIM OF PRIORITY

This application claims priority to United States Provisional Application. No. 63246317 filed on 21 Sep. 2021 titled Hierarchical Structure Learning With Context Attention From Multi-Turn Natural Language Conversations. This provisional application is hereby incorporated by reference in its entirety.

This application claims priority to, is a continuation-in-part of and incorporates herein with its entirety: U.S. patent application Ser. No. 16/917,882, filed 30 Jun. 2020 and titled VIRTUAL ASSISTANT AI ENGINE FOR MULTIPOINT COMMUNICATION.

U.S. patent application Ser. No. 16/917,882 claims priority to and incorporates herein with its entirety U.S. provisional application No. 62/869,160, filed Jul. 1, 2019, and titled VIRTUAL ASSISTANT AI ENGINE FOR MULTIPOINT COMMUNICATION. This provisional patent application is hereby incorporated by reference in its entirety.

### BACKGROUND

The process of assigning a tag or label to every member of a sequential list of observations. This process, better known as sequence labelling, has been used in Natural Language Processing, NLP, for many years, its main use in Part-Of-Speech tagging, which aims to “assign unambiguous morphosyntactic tags to words of” a corpus. One of the first such taggers for English words was the Brill's tagger, which was an “error-driven transformation-based tagger” that used supervised learning. The summary of the algorithm is to use different approaches based on whether or not the word to be tagged was known, where a known word was given its most frequent label as a tag, and an unknown word was tagged a noun. As the process was repeated, older tags were replaced, and in the end the accuracy became very high. Many machine learning methods can achieve accuracy of around 95% for POS-tagging. This same sequence labelling problem can be applied to tagging using labels separate from POS, such as entity tagging.

### SUMMARY OF THE INVENTION

In one aspect, a computerized method for implementing a neural architecture for hierarchical sequence labelling comprising: providing a neural architecture comprising a set of labelling layers, wherein the neural architecture uses a multi-pass approach on the set of labelling layers, receiving an input sentence; parsing the input sentence; embedding the input sentence into a corresponding character vector and a corresponding word vector to generate a feature vector; passing the feature vector through the neural architecture; and performing a multi-layer labelling procedure on the feature vector with the neural architecture comprising: augmenting a set of corresponding bits of the feature vector, wherein the feature vector is passed through the set of labelling layers of neural architecture, wherein each subsequent layer of the neural architecture comprises a same neural architecture with a new set of labels and produces an augmented version of the feature vector, wherein the feature vector is initially empty at a first layer of the set of labelling layers, wherein at the end of each layer of the set of labelling layers additional information is added to the feature vector such that each subsequent layer has an additional context when a labelling action is performed during a subsequent layer.

In another aspect, 1. A computerized method for implementing a neural architecture for hierarchical sequence labelling comprising: obtaining a tokenized input message comprising a set of sent message tokens and a set of received message tokens; with the neural architecture: inputting the set of sent message tokens, wherein the set of sent message tokens are passed and stored in a sent message character embedding and a GloVe (Global Vectors) word embedding; inputting the set of received message tokens, wherein the set of received message tokens are passed and stored in a received message character embedding, and the GloVe word embedding; providing a feature vector; using the sent message character embedding, the GloVe word embedding, and the feature vector to generate a first character LSTM; using the received message character embedding, the glove word embedding and the feature vector to generate a second character LSTM; using the first character LSTM to generate a send message LSTM; using the second character LSTM to generate a received message LSTM; providing the send message LSTM to an attention layer, and the attention output of the attention layer is concatenated with the received message LSTM; from the concatenated output of the attention layer and the received message LSTM, generating a contextual token representation LSTM; implementing a Wx+B function on the contextual token representation LSTM; applying a Conditional random fields (CRF) method to the output of the Wx+B function; and using the CRF output to infer a label sequence with a highest probability given a message context of the tokenized input message.

### BRIEF DESCRIPTION OF THE DRAWINGS

FIG. 1 illustrates an example of a goal-oriented dialog automation system, according to some embodiments.

FIG. 2 depicts an exemplary computing system that can be configured to perform any one of the processes provided herein.

FIG. 3 is a block diagram of a sample computing environment that can be utilized to implement various embodiments.

FIG. 4 illustrates an example response retrieval process for implementing a conversational agent, according to some embodiments.

FIG. 5 illustrates an example smart notifier framework, according to some embodiments.

FIG. 6 illustrates an example schema for a semantic frame, according to some embodiments.

FIGS. 7-10 illustrate examples of entity tagging and semantic frame extraction, according to some embodiments.

FIG. 11 illustrates an example table of a process of implementing a multi-pass hierarchical sequence framework, according to some embodiments.

FIG. 12 illustrates an example process for implementing goal-oriented dialog automation, according to some embodiments.

FIG. 13 illustrates an example semantic frame as a directed acyclic graph, according to some embodiments.

FIG. 14 illustrates an example process for implementing a hybrid neural model for a conversational AI first solution that successfully combines goal-orientation and chat-bots, according to some embodiments.

FIG. 15 illustrates an example system for implementing a virtual assistant AI engine 1502, according to some embodiments.

FIG. 16 illustrates an example process for implementing a virtual assistant AI engine, according to some embodiments.

FIG. 17 illustrates an example process for managing a guest interaction, according to some embodiments.

FIG. 18 illustrates an example process for implementing a virtual assistant AI engine, according to some embodiments.

FIG. 19 illustrates an example process for implementing a DAG frame, according to some embodiments.

FIG. 20 illustrates an example DAG frame labeler cascade, according to some embodiments.

FIG. 21 illustrates an example entity interpreter, according to some embodiments.

FIG. 22 illustrates an example multitask learning framework for multi-point communication, according to some embodiments.

FIG. 23 illustrates an example AI-based business assistant, according to some embodiments.

FIG. 24 illustrates an example neural architecture for hierarchical sequence labelling, according to some embodiments.

FIG. 25 illustrates an example architecture for the character-level embeddings for the sent message, according to some embodiments.

FIG. 26 illustrates an example architecture used herein, according to some embodiments.

FIGS. 27-29 illustrates tables provided example results, according to some embodiments.

The Figures described above are a representative set and are not exhaustive with respect to embodying the invention.

### DESCRIPTION

Disclosed are a system, method, and article of manufacture for hierarchical structure learning with context attention from multi-turn natural language conversations. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Chatbot is a computer program or an artificial intelligence which conducts a conversation via auditory or textual methods.

Conditional random fields (CRFs) are a class of statistical modeling methods often applied in pattern recognition and machine learning and used for structured prediction. A CRF can take context into account. For example, in natural language processing, linear chain CRFs are popular, which implement sequential dependencies in the predictions.

Deep neural network (DNN) is an artificial neural network (ANN) with multiple layers between the input and output layers. The DNN finds the correct mathematical manipulation to turn the input into the output, whether it be a linear relationship or a non-linear relationship. The network moves through the layers calculating the probability of each output. For example, a DNN that is trained to recognize dog breeds will go over the given image and calculate the probability that the dog in the image is a certain breed. The user can review the results and select which probabilities the network can display (e.g. above a certain threshold, etc.) and return the proposed label.

Dense layer (i.e. a fully-connected layer) refers to a layer whose inside neurons connect to every neuron in the preceding layer.

Directed acyclic graph (DAG) is a finite directed graph with no directed cycles. It can include a finite number of vertices and edges. Each edge can be directed from one vertex to another, such that there is no way to start at any vertex v and follow a consistently-directed sequence of edges that eventually loops back to v again. A directed acyclic graph can be a directed graph that has a topological ordering, a sequence of the vertices such that every edge is directed from earlier to later in the sequence.

Enterprise resource planning (ERP) system can be a system for the integrated management of core business processes. It is noted that various business management software (BMS) systems can be used in lieu of an ERP system in some example embodiments here.

Escalation matrix allows a system to specify multiple contacts to be notified in the event of specified issues/triggers.

Feature vector can be an organization of information provided by a set of descriptors as the elements of one single vector.

GloVe (Global Vectors) is a model for distributed word representation. The model is an unsupervised learning algorithm for obtaining vector representations for words. This is achieved by mapping words into a meaningful space where the distance between words is related to semantic similarity. Training is performed on aggregated global word-word co-occurrence statistics from a corpus, and the resulting representations showcase interesting linear substructures of the word vector space.

Long short-term memory (LSTM) units (or blocks) are a building unit for layers of a recurrent neural network (RNN). An RNN composed of LSTM units can be an LSTM network. A common LSTM unit is composed of a cell, an input gate, an output gate and a forget gate. The cell is responsible for remembering values over arbitrary time intervals.

Machine learning can include the construction and study of systems that can learn from data. Example machine learning techniques that can be used herein include, inter cilia: decision tree learning, association rule learning, artificial neural networks, inductive logic programming, support vector machines, clustering, Bayesian networks, reinforcement learning, representation learning, similarity, and metric learning, and/or sparse dictionary learning.

Recurrent neural networks are a class of artificial neural networks where connections between nodes form a directed graph along a temporal sequence. This allows it to exhibit temporal dynamic behavior. RNNs can use their internal state (memory) to process sequences of inputs. RNNs can model sequential data.

Semantic frame can be a collection of facts that specify characteristic features, attributes, and functions of a denotatum, and its characteristic interactions with things necessarily or typically associated with it. The semantic frame captures specific pieces of information that are relevant to summarizing and driving a goal-oriented conversation.

Tokenization can include the process of breaking a stream of text up into words, phrases, symbols, or other meaningful elements called tokens which represent the basic unit processed by the NLP system. The list of tokens becomes input for further processing such as parsing or text mining. Tokenization is the process of demarcating and/or classifying sections of a string of input. The resulting tokens can then be passed on to some other form of processing.

Wx+b=0, defines a hyperplane. For ∥W∥=1, the weights, W, determine the orientation of the plane while the bias term b determines the perpendicular distance from the plane to the origin. Wx+b can be an activation value that encodes how far from and to which side of the decision hyperplane or boundary an input point x falls. b can the bias and is equivalent to a threshold, W.x can the dot product of W (e.g. a vector which component is the weights), and x (e.g. a vector consisting of the inputs).

Xavier initialization can be used to improve the initialization of neural network weighted inputs. For example, the weights of the network are selected for specified intermediate values. These can initialize the weights such that the variance of the activations are the same across every layer. Improving the constancy of the variance can be used to prevent a gradient from exploding or vanishing.

Example Computer Architecture and Systems

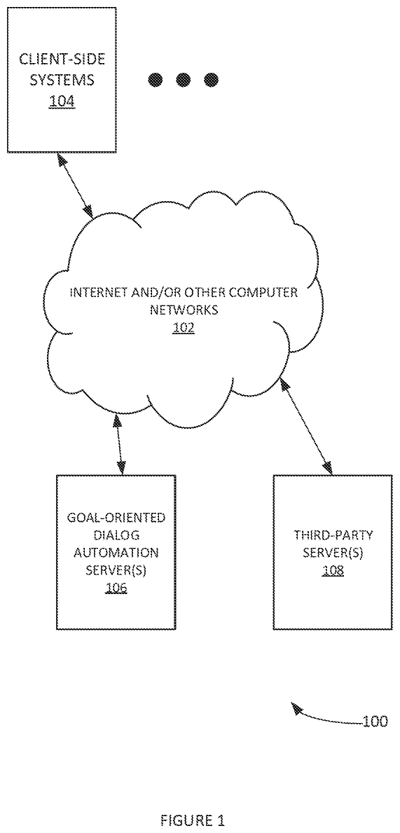

FIG. 1 illustrates an example of a goal-oriented dialog automation system 100, according to some embodiments. Users can use client-side systems (e.g. mobile devices, telephones, personal computers, etc.) to access the services of goal-oriented dialog servers 106 via input messages. Input messages can include, inter alia: voice messages, text messages, etc.

System 100 can include various computer and/or cellular data networks 102. Computer and/or cellular data networks 102 can include the Internet, cellular data networks, local area networks, enterprise networks, etc. Networks 102 can be used to communicate messages and/or other information from the various entities of system 100.

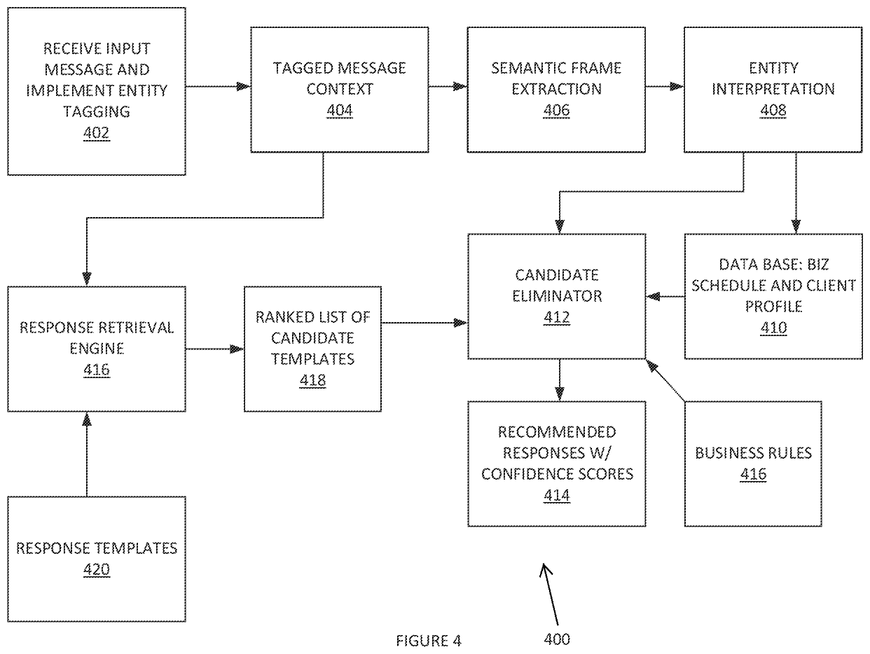

Goal-oriented dialog servers 106 can implement the various process of FIG. 4-13 Goal-oriented dialog servers 106 can obtain an input message at time t, mt, which is sent through a hierarchical sequence labelling based entity tagger (e.g. see entity tagging and semantic frame extraction embodiments and steps infra). The labelled message along with the tagged message context is then used by the semantic frame extractor (e.g. see entity tagging and semantic frame extraction embodiments and steps infra) which generates a semantic frame, Ft (see semantic frame implementations infra). The semantic frame can be a complete representation of the conversation till time t and, holds information about the specific entities being spoken about. Accordingly, the entities can be mapped to a standard name. This mapping can be implemented in an entity interpretation phase (see entity interpretation processes infra). The interpreted request can then be sent to the database to check whether it can be satisfied (e.g. to check if the business' schedule has availability for the requested services). The labelled message and tagged message context can also be sent to a response retrieval engine which ranks a universe of response templates. A response template can be/include a canonical response. The canonical response can capture the semantic nature of the sentence, while being completely agnostic to the values of the actual entities. For example, one potential template response could look like

[symbol]

STAFF [symbol] is available at [symbol] TIME-HOURMIN [symbol] at [symbol] LOCATION [symbol] . This ranked list of candidate templates can then be passed to a candidate extractor whose task is to ensure that any responses going out of it are semantically consistent with the semantic frame and the availability returned by a relevant database (DB) if this is not in violation of any business rules. Examples of business rules can include, inter alia: requirement to provide a two-hour notice to book a massage; cannot cancel appointments with John with less than twenty-four hours of notice; etc. Based on the confidence scores of the entries in this filtered list of responses, the message can either directly send to the user, or is forwarded to an artificial intelligence (AI) trainer for manual verification (e.g. which provides relevance feedback and supervised data to retrain the retrieval engine, etc.). In addition to responding to messages sent by the user, the system allows for event-based triggers. These triggers may be rule based (for example, the workflow may require reminders to be sent to the user periodically) or based on the output of a classifier (e.g. in case a caller is becoming irate it might be prudent to pause the automated responses and forward the request to the concerned people). Each of these triggers can independently send the relevant notification to the smart notifier. The message can then be routed to either a specified user or a member of the business/staff. This framework can run in parallel with the response retrieval framework to provide a cohesive, end-to-end goal-oriented dialogue automation system. The subsequent sections capture details of the components described above along with a description of the techniques used.

Third-party servers 108 can be used to obtain various additional services. These services can include, inter alia: ranking systems, search-engines, language interpretation, natural language processing services, database management services, etc.

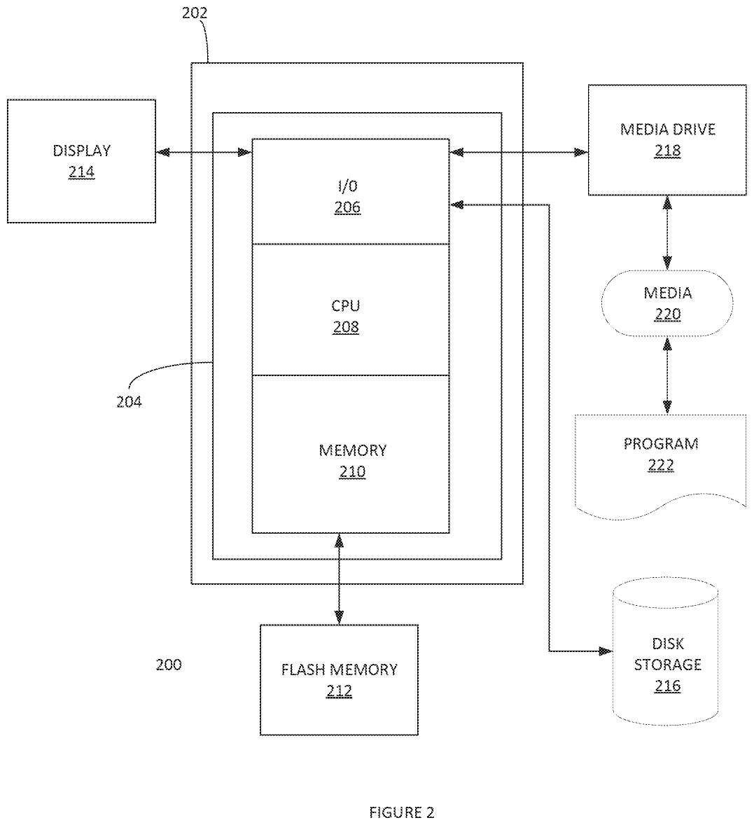

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

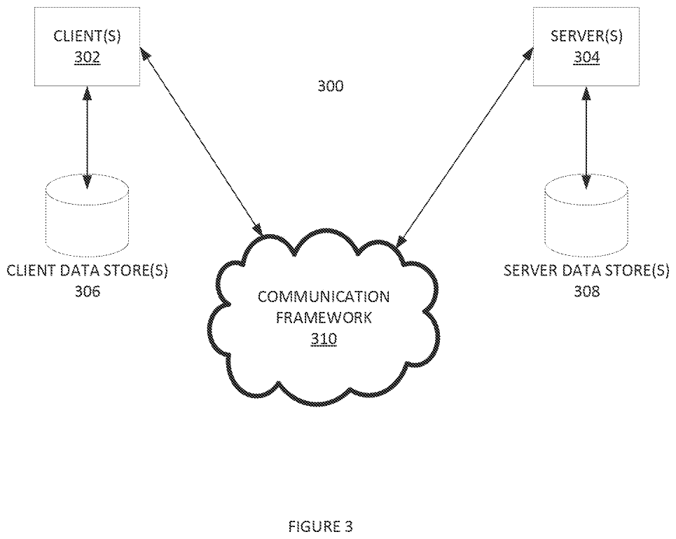

FIG. 3 is a block diagram of a sample computing environment 300 that can be utilized to implement various embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting a cloud-computing platform.

### Exemplary Methods

FIG. 4 illustrates an example response retrieval process 400 for implementing a conversational agent, according to some embodiments. Example conversational agents can be based on response retrieval process 400. In step 402, framework 400 can receive input messages and implement entity tagging. In step 404, process 400 tags the message context. In step 406, process 400 can implement semantic frame extraction. In step 408, process 400 can implement entity interpretation. In step 410, process 400 can access a database to determine a business schedule and client profile. In step 412, process 400 can implement a candidate eliminator. Step 412 can incorporate use of business rules 416. In step 414, based on the output of step 412, process 400 can recommend responses with confidence scores 414.

Process 400 can also implement a response retrieval engine 416. Response retrieval engine 416 can obtain response templates 418. Response retrieval engine 416 can obtain a tagged message context. Process 400 can also implement a response retrieval engine 416. Response retrieval engine 416 can generate a ranked list of candidate templates 418 to candidate eliminator step 412.

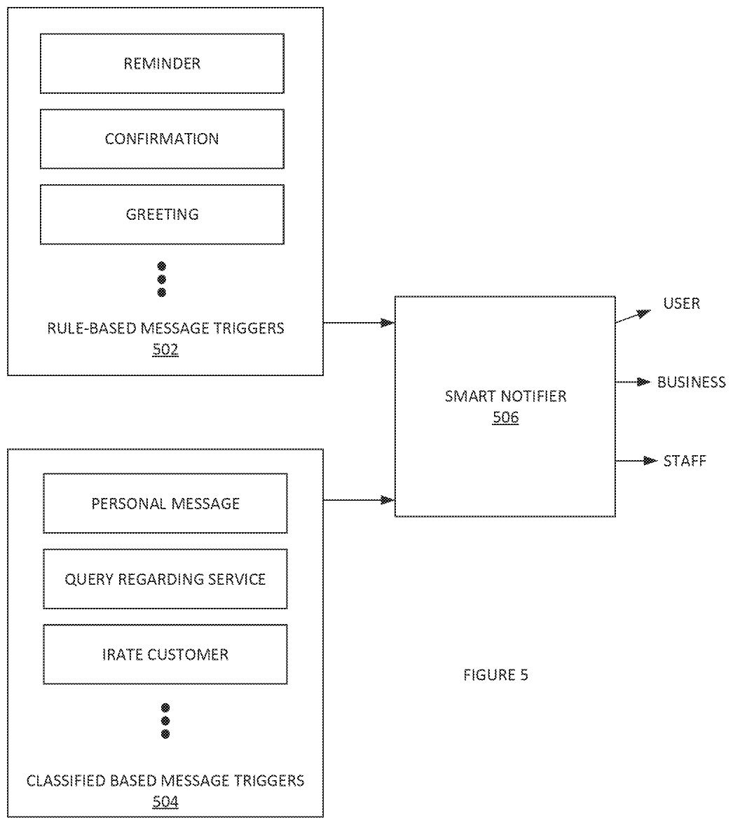

FIG. 5 illustrates an example smart notifier framework 500, according to some embodiments. Smart notifier framework 500 can run in parallel to the response retrieval framework of process 400. There can be two avenues by which an event may be triggered: rule-based message triggers 502 and/or classifier-based message triggers 504. Rule based triggers 502 can be independent of the state of a conversation. An event ‘e’ can be fired based upon the business information available and the client's profile (e.g. as provided in process 400 supra). For example, the event ‘e’ can be an event to remind the user to add their credit card details. ‘e’ can be triggered if the business requires a user's credit card to be on file, and each reminder event will check the user's profile to validate whether the details have been provided. Classifier based triggers 504 can be classifiers that depend upon an immediate dialogue text. There can be individual classifiers for each potential trigger. These classifiers can take as input the message ‘mt’ and output whether or not an event needs to be triggered and if so, to whom. These events can then trigger messages to the appropriate person (e.g. based upon the content of the event).

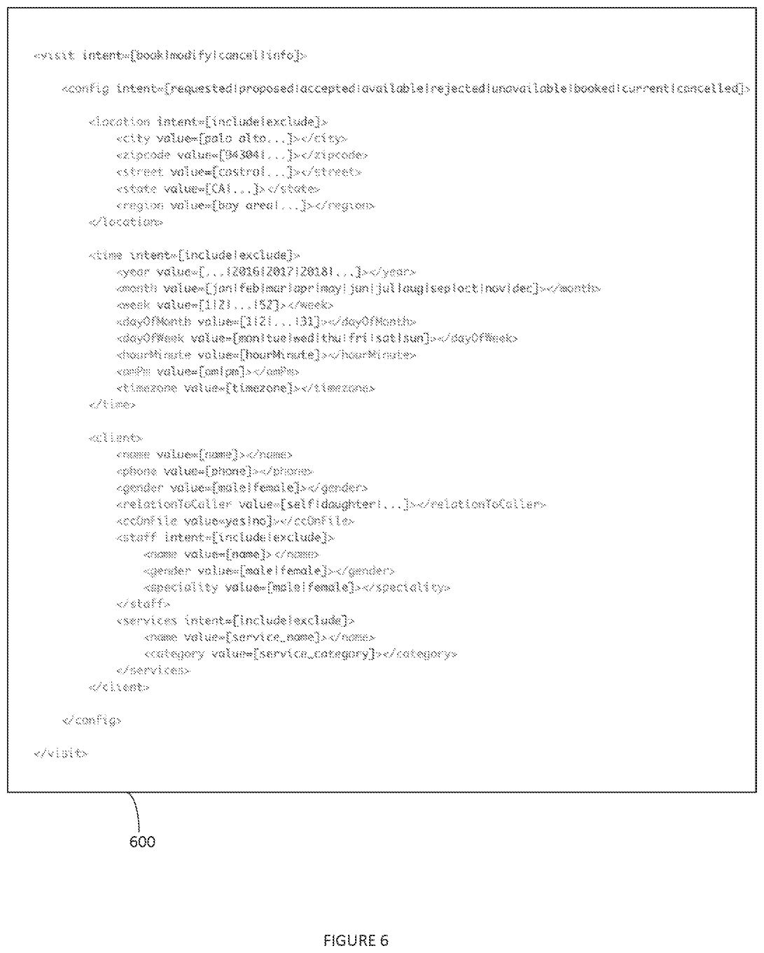

FIG. 6 illustrates an example schema for a semantic frame 600, according to some embodiments. A semantic frame can be used to express the structured information in a dialog session. In one example, the semantic frame for a dialogue ‘Dt’ can be denoted by ‘Ft’. The semantic frame is updated with each new message that is sent and/or received in a session. A semantic frame can be a simple collection of slots along with an associated intent. Each slot can hold the value of an entity (e.g. a name, a phone number, date, etc.) and/or it can in-turn reference another frame (e.g. a client's profile, a booking request, etc.). In a fully instantiated semantic frame, its slots recursively resolve to a collection of entity values. FIG. 6 illustrates an example schema. While this example lists frames corresponding to the book, modify, cancel or info intents, the structure can be extended in other ways to address multiple intents (e.g. identification of spam calls, calls requiring immediate business attention, etc.). The semantic frame Ft for a dialog Dt can be visualized as a Directed Acyclic Graph, where each node is a frame (or sub-frame) and its child nodes are the corresponding slots in that frame. When a slot contains an entity value, it can become a leaf node. In another example, the graph can become deeper by one more level to represent another sub-frame. Nodes in the graph can be labelled by the type of the frame (or slot) that it represents. When there are multiple nodes of the same type and at the same level, they are numbered in order to assign each of them a unique label. Edges in the graph can be labelled with an intent, that qualifies the relationship between the nodes that it connects.

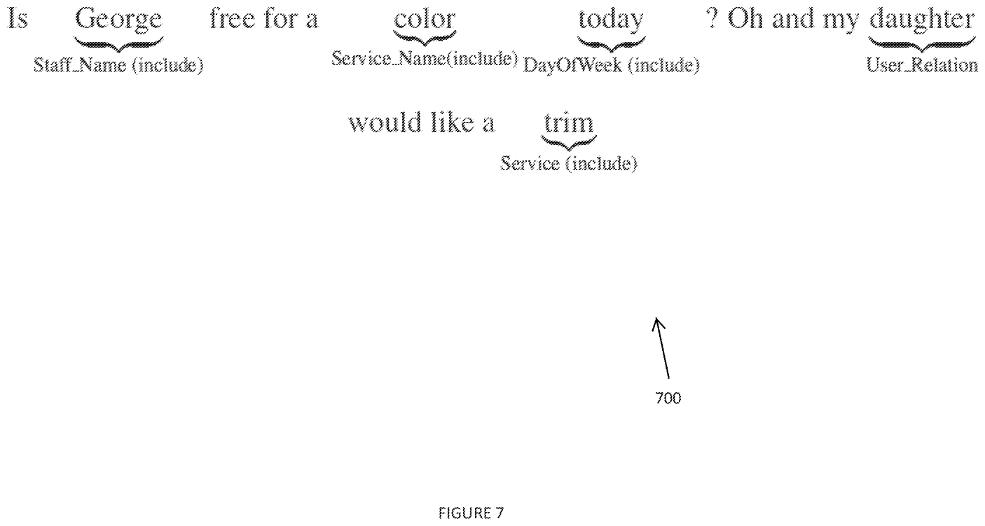

FIGS. 7-10 illustrate examples of entity tagging and semantic frame extraction, according to some embodiments. Structure (e.g. semantic frames) from a conversation dialog can reduce to labelling the sequence of text tokens that constitute it. Any set of one or more tokens in the dialog (e.g. contiguous or otherwise, within a single utterance or across multiple utterances) can be assigned a label. The tokens in a dialog that constitute a frame (and/or sub-frame) are assigned the label obtained by the concatenation of the frame-type (or slot-type) and its associated intent (if one exists). Hierarchical sequence labelling can be used to infer frames from conversational dialog. At the most granular level, the tokens can be tagged as belonging to one of the leaf nodes of the graph along with their corresponding intents.

More specifically, FIG. 7 illustrates an example tagging of an example sentence:

m1: ‘Is George free for a color today? Oh and my daughter would like a trim’.

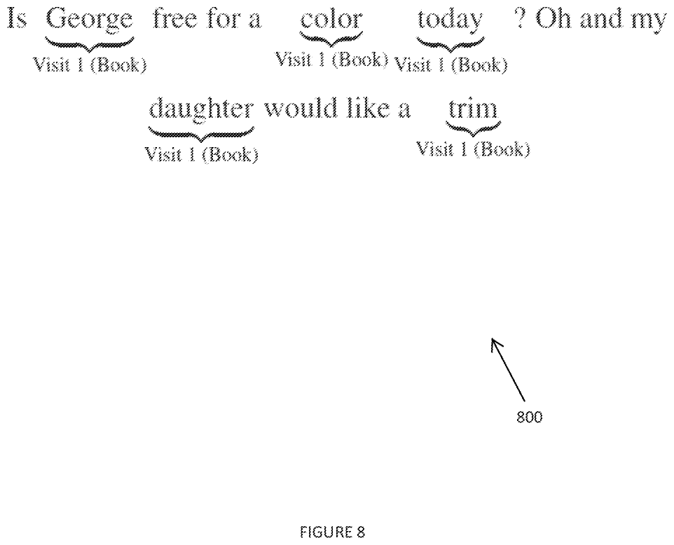

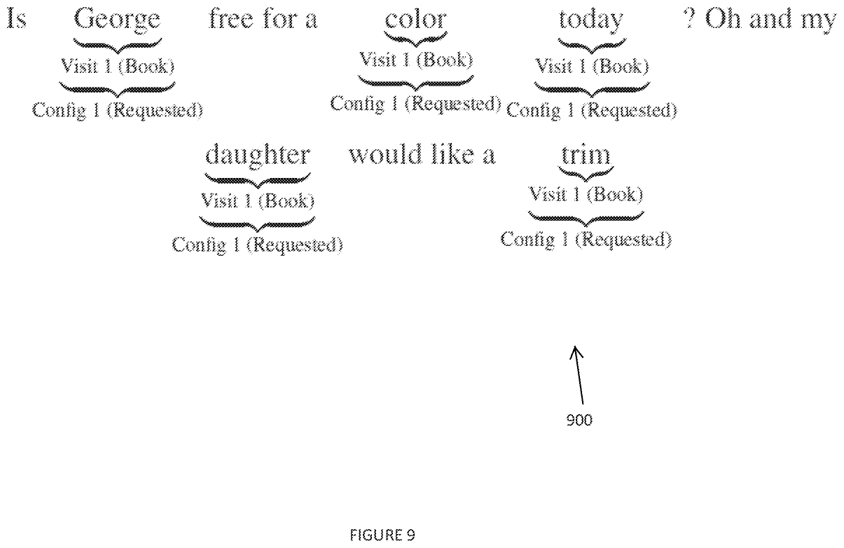

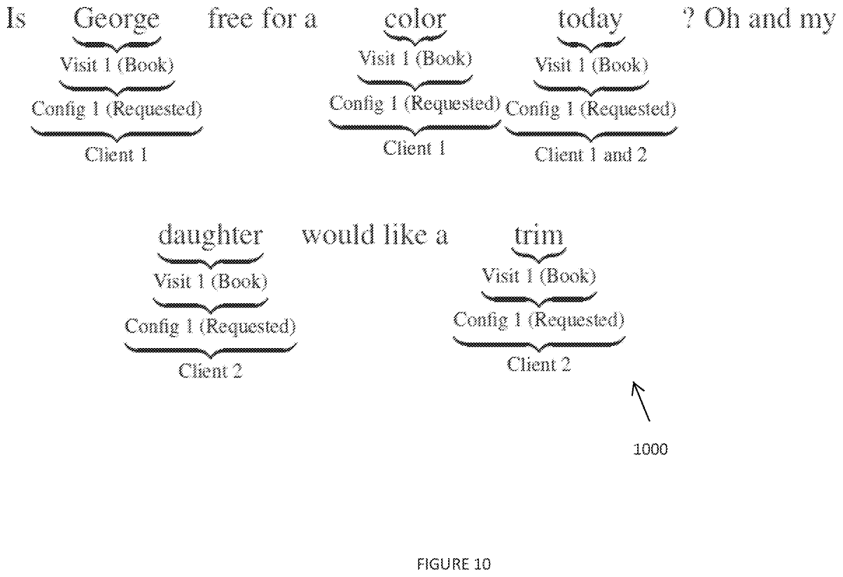

The process shown in FIG. 7 provides a set of entity labels. To extract actionable information from the conversation, additional information about the association between these entities can be obtained. For example, it can be determined which person required the color service and who needed the haircut. In order to capture this multiplicity of configurations, a multi-pass hierarchical sequence framework can be generated. The sentence of FIG. 7 can be first passed through the multi-pass hierarchical sequence framework in order to tag the entities at the highest level in the graphical representation of the semantic frame to generate the content of FIG. 8. A second pass over the sentence can reveal no new visits in the conversation and would thus proceed to the next hierarchical level in the graph-configurations, as provided in FIG. 9. The next pass can once again reveal no new configurations, and the process can proceed to the next level—client. As shown in FIG. 10, labels can be obtained for both the first and the second pass since there are two clients being spoken of. Thus, each pass captures the key information in a dynamically evolving hierarchy of semantic frames. While there is a regularity to the structure of the evolving hierarchy, the size and shape of the directed acyclic graphs changes dynamically as the conversation proceeds. It is noted that if no labels are assigned for a particular pass, the process proceeds to a next level in the hierarchy of the multi-pass hierarchical sequence framework until the leaf nodes are reached.

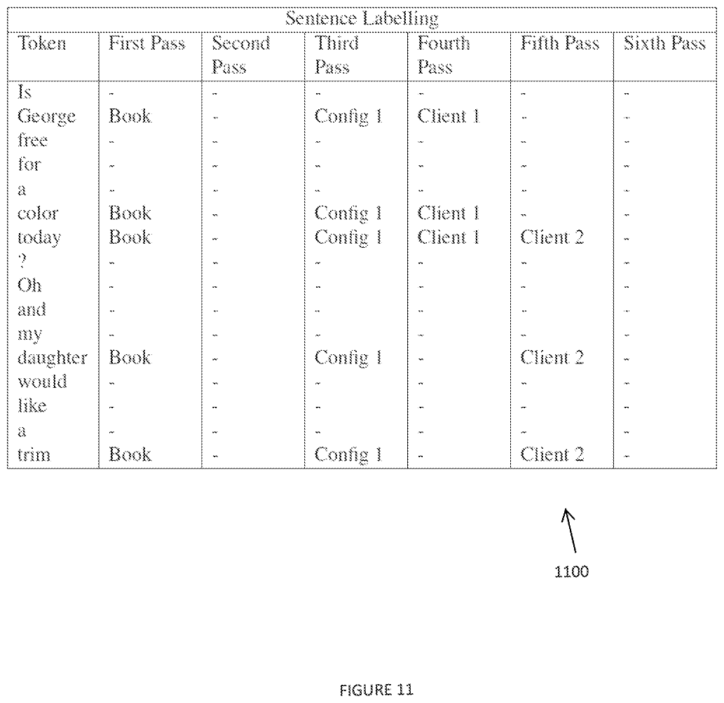

FIG. 11 illustrates an example table 700 of a process of implementing a multi-pass hierarchical sequence framework, according to some embodiments. Table 700 illustrates the sequential nature of the multi-pass hierarchical sequence framework process.

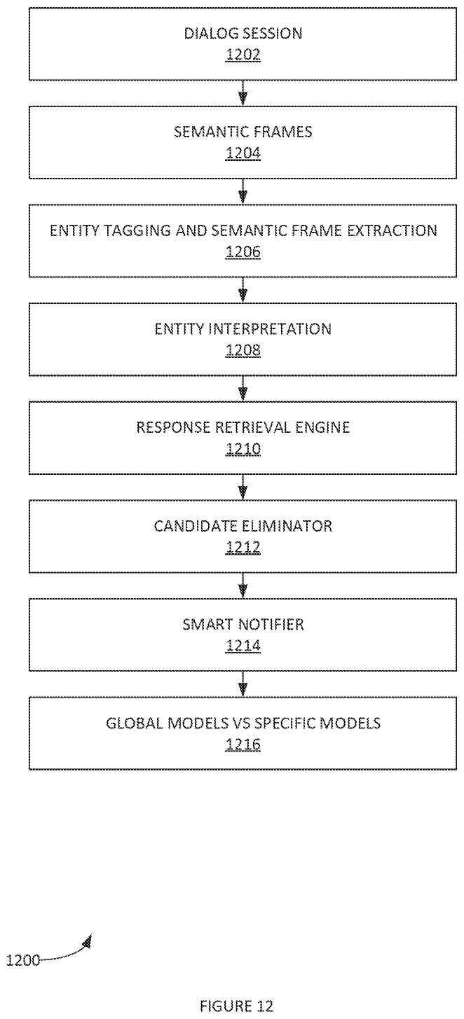

FIG. 12 illustrates an example process for implementing goal-oriented dialog automation, according to some embodiments. In step 1202, process 1200 can implement a dialog session. The dialog session can comprise a set of utterances or messages. The dialog session can be in a computer-readable format and obtained from voice message, text message, electronic mail content, etc.

In step 1204, process 1200 can implement semantic frames. Additional information for implementing semantic frames is provided herein.

In step 1206, process 1200 can implement entity tagging and semantic frame extraction. Step 1206 can provide a set of tokens in a dialog that constitute a frame (or sub-frame) which are assigned the label obtained by the concatenation of the frame-type (or slot-type) and its associated intent (if one exists). Hierarchical sequence labelling can be used to infer frames from conversation/message(s).

In step 1208, process 1200 implements entity interpretation. During frame inference, one or more tokens may be assigned to a particular slot as its value. For example, a pair of successive tokens, ‘men's haircut’, may be inferred as a ‘requested service’. In order to interpret the request, the slot value can be mapped into appropriate entries in the database. This mapping can be easy if there is an exact match of the slot value with the corresponding service(s) in the database. However, in some examples, this may not be the case. The slot may contain misspelled words, acronyms, common (and/or uncommon) alternative ways to reference a service, etc. In some examples, a single-token slot value can map to multiple database (DB) entries, and at other times, multiple-token slot values may map to a single DB entry. A learning model can be applied. For example, let v denote the slot-value that needs to be mapped. Let C denote a list of candidate DB entries that v can be mapped into. For each c ∈ C, process 1200 can construct a feature vector f(v; c) that measures various aspects of v and c individually, as well as the extent of match between v and c. Process 1200 can then learn a ranker that takes the set {f(v; c): c ∈ C} as inputs and outputs the most relevant entries in the database that v can map into, along with their corresponding confidence scores. This sorted list can then be used to interpret the request for further processing.

[symbol]

[symbol]

In step 1212, process 1200 can implement a candidate eliminator. An example candidate eliminator process is now discussed. For example, Mₜ={mᵢ_{₁}, mᵢ_{₂}, . . . , mᵢ_{ₖ}} can denote the rank-sorted list of top-k response-templates returned by the retrieval engine for the input context Dt. Not all response-templates may be valid for use in the current context. For example, mil may be meant to recommend availabilities, but as per the schedule, there may actually be none. The candidate eliminator runs down this list and returns only those responses which are valid given the current state of the semantic frame and database.

In step 1214, process 1200 can implement a smart notifier. As noted, this portion of the pipeline can run in parallel to the response retrieval framework described herein. There are two avenues by which an event may be triggered.

In a first example, rule-based triggers can be implemented. In a second example, classifier-based triggers can be implemented. These classifiers can depend upon the immediate dialogue text. There can be individual classifiers for each potential trigger and these classifiers take as input the full session context Dt and any new incoming message and output whether or not an event needs to be triggered and if so, to whom. These events then trigger messages to the appropriate person (e.g. based upon the content of the event).

In step 1216, process 1200 can implement global models and/or specific models. For example, a business may have certain response templates which occur frequently in conversation but are not applicable to other businesses. Having a single universe of response templates across businesses does not cater to these scenarios and stifles the organic development of the system. Two bags of response templates can be utilized. One bag of response templates can be a global bag of response templates. Another bag of response templates can be a business specific bag of response templates. As noted, on receipt of a user utterance ‘ut’ and a dialogue context ‘Dt’, then each message mᵢ in the global response templates can be given a score global ξ^{global}(Dₜ, mᵢ) ∈ [symbol] . Additionally, another model can independently ascribe the business specific templates to a score business ξ^{business}(Dₜ, mᵢ) ∈ [symbol] . These two scored lists of responses can be sent to the candidate eliminator for filtering.

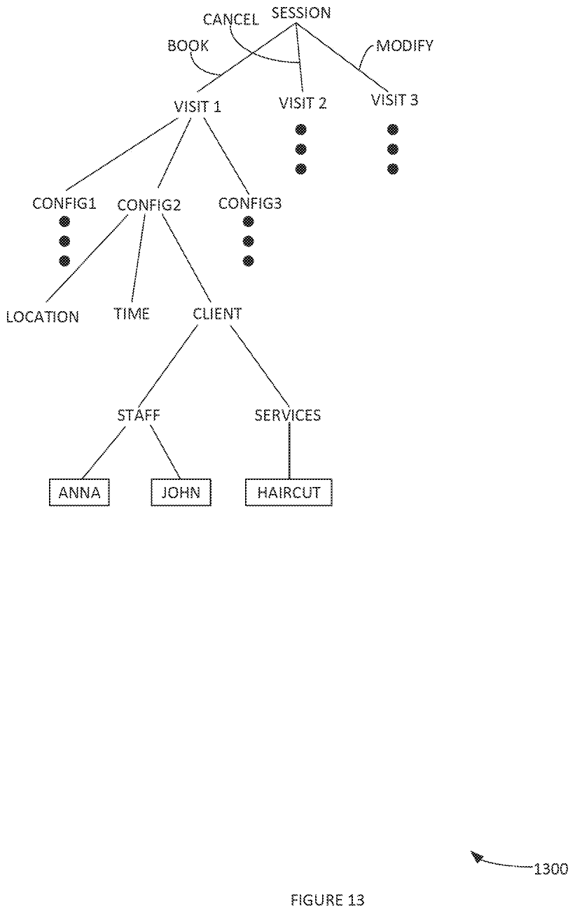

FIG. 13 illustrates an example semantic frame as a directed acyclic graph 1300, according to some embodiments. Directed acyclic graph 1300 is a graphical representation of the semantic frame examples discussed supra. Directed acyclic graph 1300 includes hierarchical levels as shown. Process 1200 tags tokens of the input message as belonging to a relevant leaf node(s) of directed acyclic graph 1300 along with their corresponding intents. FIGS. 7-10 illustrate the passing of an input message through the illustrated hierarchical levels and the resulting output.

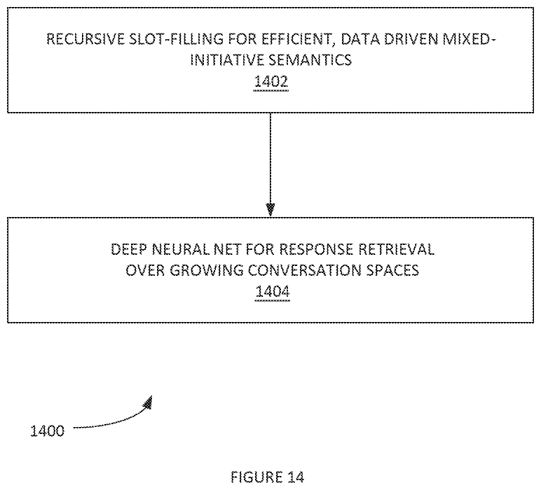

FIG. 14 illustrates an example process for implementing a hybrid neural model for a conversational AI first solution that successfully combines goal-orientation and chat-bots, according to some embodiments. In step 1402, process 1400 implements a recursive slot-filling for efficient, data driven mixed-initiative semantics. In step 1404, process 1400 implements a deep neural network for response retrieval over growing conversation spaces.

### Additional Embodiments

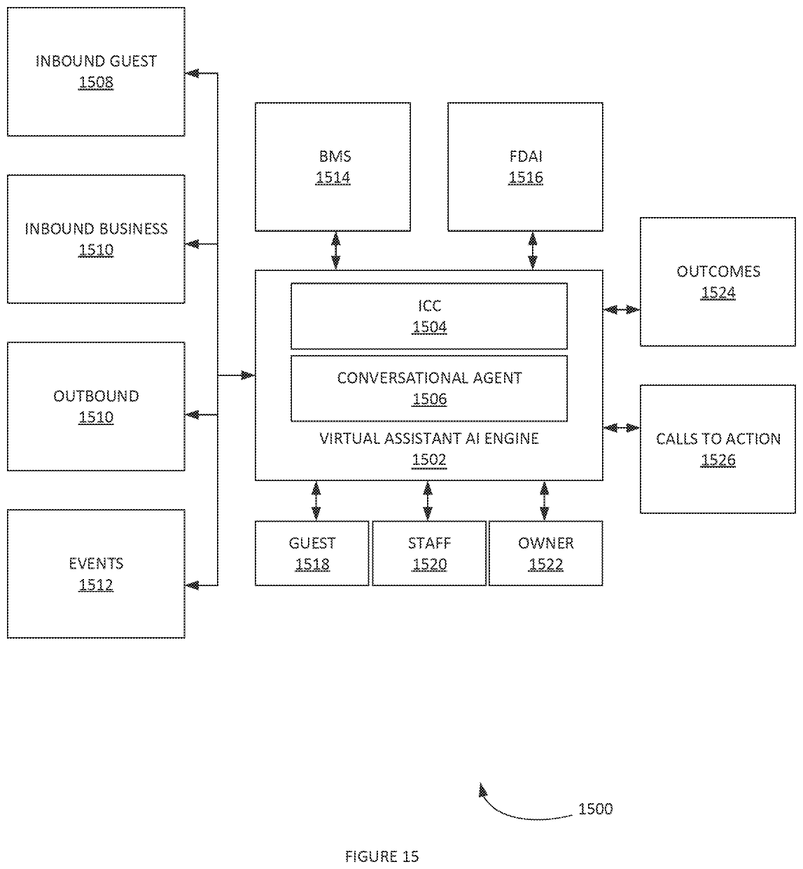

FIG. 15 illustrates an example system 1500 for implementing a virtual assistant AI engine 1502, according to some embodiments. System 1500 includes virtual assistant AI engine 1502. Virtual assistant AI engine 1502 provides a complete virtual assistant and preserves a human-like touch. The virtual assistant can be simple to on-board, use, and teach over time. Virtual assistant AI engine 1502 includes an intelligent control center (ICC) 1504. ICC 1504 can generate outcomes 1524 and calls to action 1526. ICC 1504 can use machine learning algorithms. ICC 1504 can summarize outcomes 1524 of the caller's interactions with the virtual assistant and can recommend the calls to action 1526. ICC 1504 can use machine learning algorithms. Outcomes 1524 can include, inter alia: new appointments, membership requirements, provided information, timeliness states (e.g. running late, early, etc.), insufficient information, unresponsive status, etc. There can be one or more outcomes 1524 for a particular virtual-assistant conversation.

A second category of output can be a call-to-action 1525. Calls to action 1526 can be an additional action that remains pending after the virtual assistant AI engine 1502 provides an answer and/or determines a set of outcomes. Calls to action 1526 can include, inter alia: call client back, provide information, collect payment information, cancel booking, etc. These can be forwarded to an appropriate entity (e.g. staff, owner, third-party service provider, etc.). It is noted that virtual assistant AI engine 1502 can use prediction methods to determine outcomes 1524 and/or calls to action 1526. In this way, virtual assistant AI engine 1502 extends the functionality of a chat bot to a full front-desk communication automation system that uses the conversation AI engine based on mixed initiative dialog with goal orientation (MIDGO) technology. Virtual assistant AI engine 1502 can take a variety of triggers and subsequent conversation content as an input and intelligently determine a variety of outcomes 1524 and/or calls to action 1526 to be delivered as output. Virtual assistant AI engine 1502 can utilize a proprietary data store to augment BMS 1514 of the business/enterprise.

Virtual assistant AI engine 1502 includes a conversation agent 1506. Conversation agent 1506 is a computer system intended to converse with a human with a coherent structure. Dialogue systems have employed text, speech, graphics, haptics, gestures, and other modes for communication on both the input and output channel. Conversation agent 1506 can implement a MIDGO AI module (e.g. FDAI 1526, etc.). Conversation agent 1506 can recognize when to initiate conversations and when to respond. Based on what events occurs during the conversation, conversation agent 1506 can determine which messages should be generated and sent to either a business owner and/or staff (e.g. regarding a specific issue such as an imminent appointment cancellation, scenarios that require immediate attention, a client is locked out of a building, etc.). Conversation agent 1506 can facilitate an automatic communication between the guest/customer and the staff/owner when virtual assistant AI engine 1502 such a scenario. In this way, virtual assistant AI engine 1502 can implement a multipoint communication system between users 1518, staff 1520, owners 1522, etc. and conversation agent 1506. Virtual assistant AI engine 1502 can manage a plurality of conversational goals within the multipoint system as multiple-related conversations occur. A plurality of outcomes can emerge from a single initial conversation, these can be managed to determine outcomes 1524 and calls to action 1526.

Virtual assistant AI engine 1502 can initiate natural-language conversations with users (e.g. customers, business/enterprise employees, third-party suppliers, etc.) based on triggers 1508-1516. Triggers 1508-1516 can include, inter alia: inbound customer/guest trigger(s) 1508, inbound business trigger(s) 1510, outbound trigger(s) 1512, event trigger(s) 1514, etc. Inbound customer/guest trigger(s) 1508 can include, inter alia: missed calls, voicemails, direct text messages, web chats, etc. Triggers can be initiated by users 1518, staff 1520, owners 1522, etc.

Virtual assistant AI engine 1502 can integrate with various business management software (BMS) 1514. BMS 1514 can include, inter alia: point a sale, an ERP system, etc. BMS 1514 can include any system a business/enterprise uses to run day to day operations and can be a book of record for appointments/orders for the business/enterprise. Virtual assistant AI engine 1502 can use this BMS 1514 to access business information (e.g. open times/schedules, products/services available, time to fulfillment, cost structures, etc.). Virtual assistant AI engine 1502 can access via an API. Virtual assistant AI engine 1502 can query BMS 1514 for data and setting up appointments, etc. Virtual assistant AI engine 1502 can augment information in BMS 1514 with other data sources (e.g. cancellation policy, alternative recommendations based on user queries, expose additional service names if new scenarios are presented, etc.) without exposing a different service name. In this way, virtual assistant AI engine 1502 can fill in any gaps in the booking software, FAQs, business rules, etc. of the business/enterprise in a seamless manner. Virtual assistant AI engine 1502 can store and analyze incoming queries and use these to supplement the functionalities of BMS 1514. Virtual assistant AI engine 1502 can use FDAI 1516 to implement this extension of the various BMS functionalities.

FDAI 1516 can be a third-party automated assistant solution provider. FDAI 1516 can write dynamic augmenting information back into and add to the BMS functionalities. In this way, FDAI 1516 can update and supplement virtual assistant AI engine 1502 and BMS 1514 to adapt to the content of triggers, etc.

It is noted that there are two parts for the artificial intelligence functionalities, including, inter alia: comprehending incoming text and responding to said incoming text. The AI functionalities can automatically infer from conversation to predict calls to actions and update BMS based on call to action as an outcome from conversation. In other words, a first part includes the ability to comprehend caller's requests and suitably respond in natural language. A second part is the ability to summarize the outcomes from such interactions, push updates or changes to the BMS and the augmented business information database, and recommend relevant calls to action for the business.

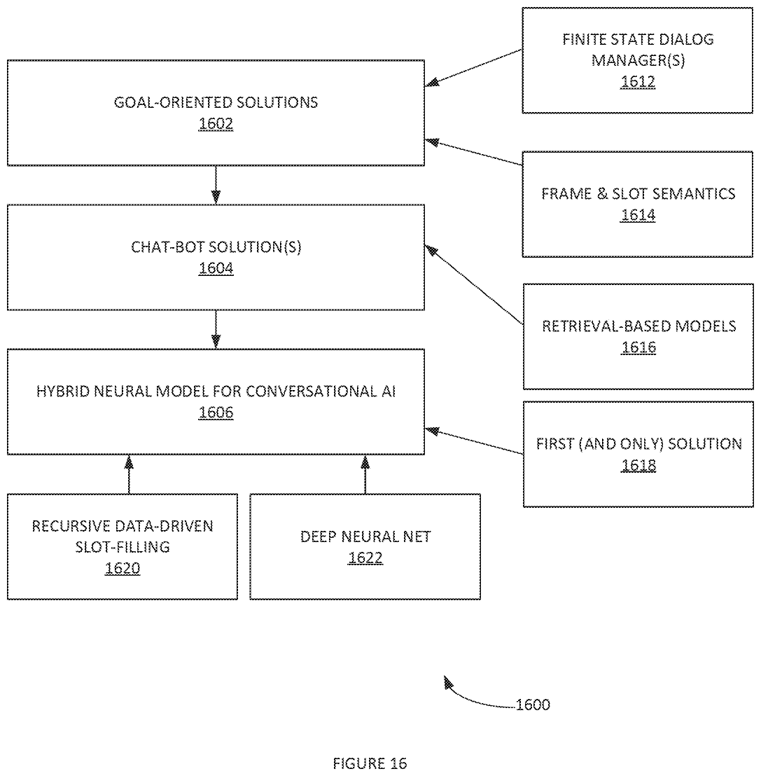

FIG. 16 illustrates an example process 1600 for implementing a virtual assistant AI engine, according to some embodiments. In step 1602, process 1600 can obtain goal-oriented solutions (e.g. book airline tickets, take orders in retail, etc.). Goal-oriented solutions can include complete pre-defined tasks/goals. Step 1602 can utilize finite-state dialog manager(s) 1612 and/or frame and slot semantics 1614. Finite-state dialog manager(s) 1612 can include single initiative and/or universals. Frame and slot semantics 1614 can include crafted patterns.

In step 1604, process 1600 can implement chat-bot solutions. Chat-bot solutions can use retrieval-based models. Chat-bot solutions can include, inter alia: learn over large data sets, may not be goal-oriented (e.g. no task completion), and implement shallow conversations.

In step 1606, process 1600 can implement a hybrid neural model for conversational AI. Hybrid neural model for conversational AI can implement: a first (and only) solution that combines goal-orientation and chat-bots; recursive data-driven slot-filling for mixed-initiative semantics 1620; and deep neural net 1622 for response retrieval over growing conversation spaces.

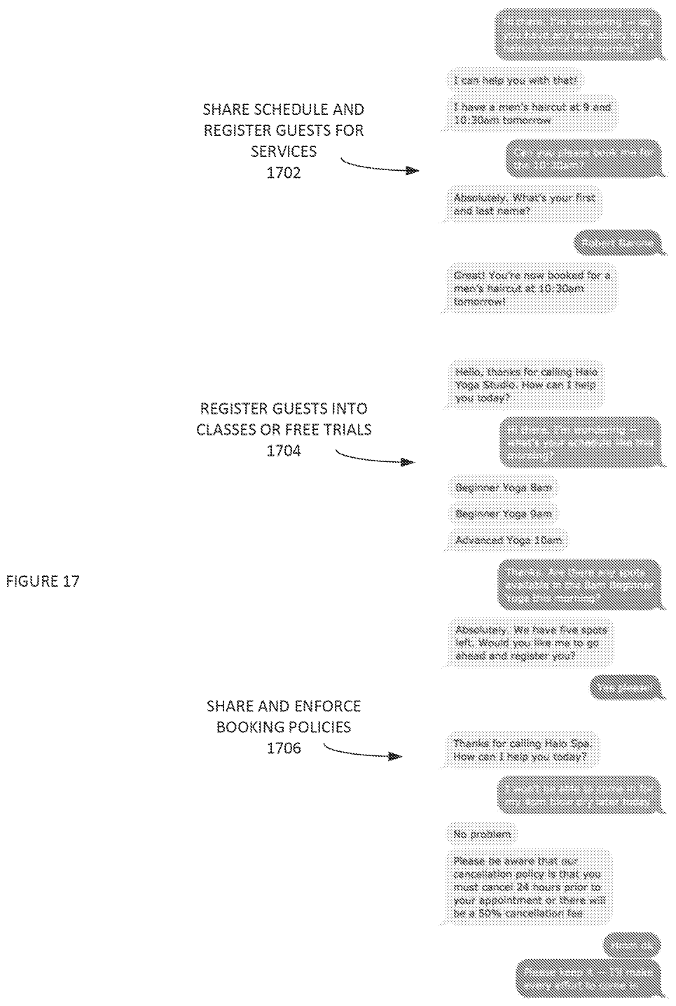

FIG. 17 illustrates an example process 1700 for managing a guest interaction, according to some embodiments. In step 1702, process 1700 can Share schedule and register guests for services. In step 1704, process 1700 can register guests into classes or free trials. In step 1706, process 1700 can share and enforce booking policies.

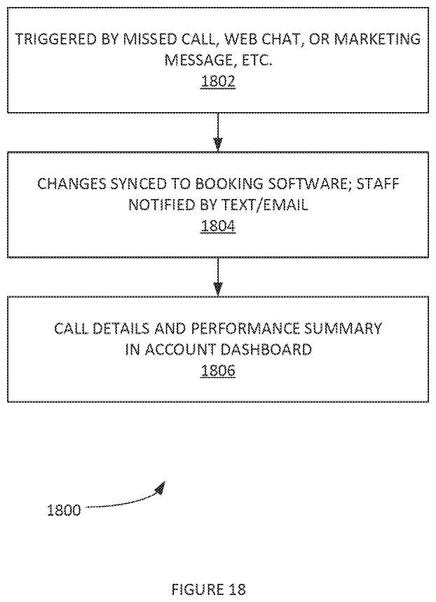

FIG. 18 illustrates an example process 1800 for implementing a virtual assistant AI engine, according to some embodiments. In step 1802, process 1800 can be triggered by missed call, web chat, or marketing message, etc. In step 1804, process 1800 can implement changes synced to booking software and the STAFF can be notified by text/email. In step 1806, process 1800 can implement call details and performance summary in account dashboard.

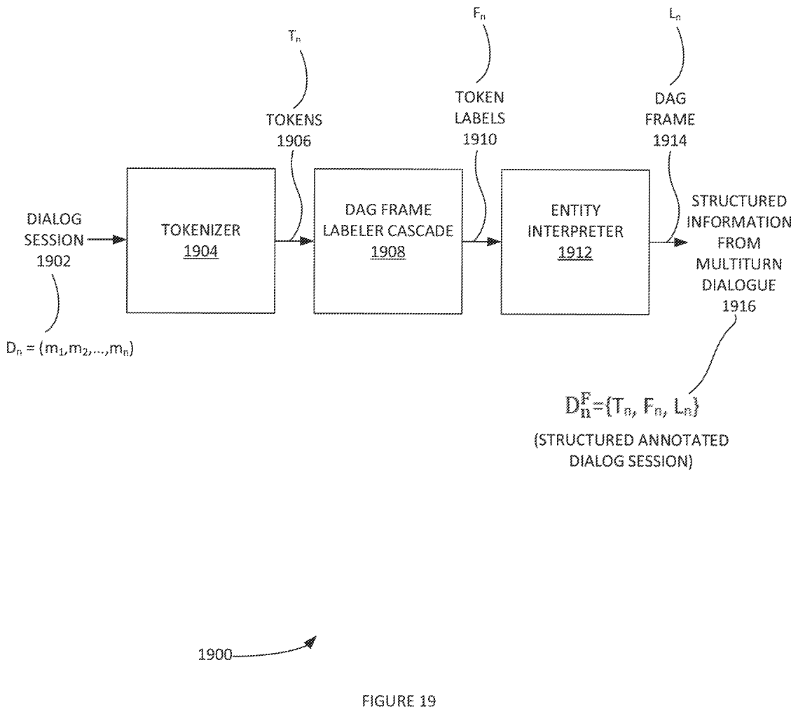

FIG. 19 illustrates an example system 1900 for implementing a DAG frame, according to some embodiments. The DAG frame can be a MIDGO AI semantic frame. System 1900 describes how a dialog session (e.g. a sequence of messages, etc.) is received as input. The sequence of messages can be an exchange of messages. This can include messages from a customer to a system (e.g. AI-based business assistant 2300, etc.) and messages from the system to a customer and/or other relevant entities. The output of system 1900 can be a DAG frame (e.g. see infra). System 1900 may not need to pass the messages through a deep NLP model.

Process 1900 can receive a dialog session 1902. Herein, dialog session 1902 is represented as: Dₙ=(m₁,m₂, . . . ,mₙ). mₙ is a new inbound message. Dialog session 1902 is fed to tokenizer 1904. Tokenizer 1904 generates tokens 1906, Tₙ, from Dₙ=(m₁,m₂, . . . ,mₙ) by breaking the messages into a sequence of tokens. Tokens 1906, Tₙ, are then provided to DAG frame labeler cascade 1908. DAG frame labeler cascade 1908 uses sequence of tokens 1906, Tₙ, to generate token labels 1910, Lₙ. Token labels 1910, Lₙ and/or tokens 1906, Tₙ, are then passed to entity interpreter 1912. Entity interpreter 1912 generates a DAG frame 1914. DAG frame 1914 in turn outputs structured information from multiturn dialogue 1916. Structured information from multiturn dialogue 1916 is represented by Dₙ^{F}={Dₙ, Tₙ, Lₙ, Fₙ} herein. Dₙ^{F}={Dₙ,Tₙ, Lₙ, Fₙ} represents the structure-annotated dialog session.

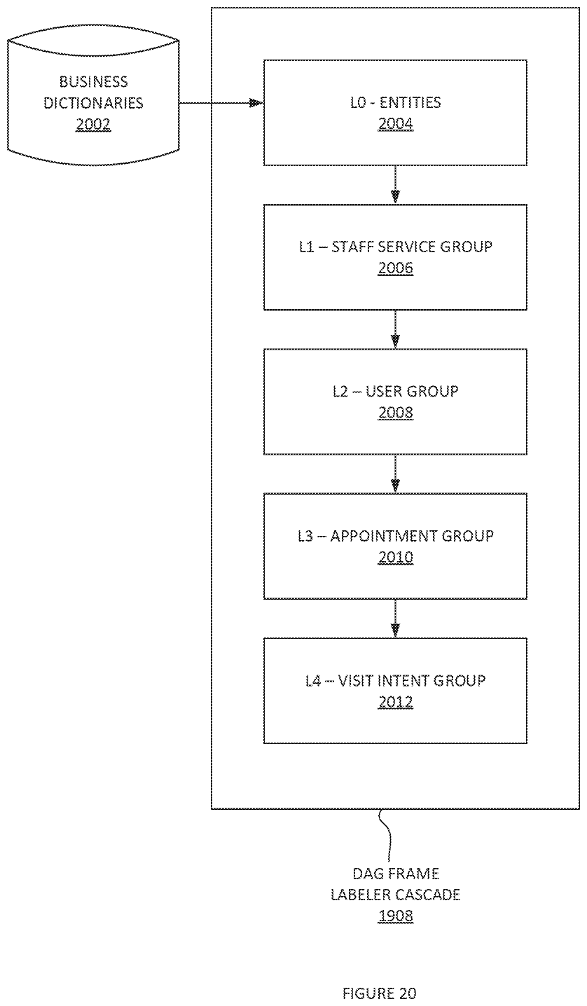

In one example, DAG frame labeler cascade 1908 can extract structured information from the conversation. FIG. 20 illustrates an example DAG frame labeler cascade 1908, according to some embodiments. DAG frame labeler cascade 1908 can access business dictionaries 2002. Business dictionaries 2002 can define staff, services, locations, and/or any other relevant entities.

The input to the DAG frame labeler cascade is then passed through various levels. Example levels of the DAG frame labeler cascade 1908 include, inter alia: L0—entities 2004, L1—staff service group 2006, L2—user group 2008, L3—appointment group 2010, L4—visit intent group 2012. The output of each level augments the input of the next level and so on. L0 can detect entities using business dictionaries 2002. L1 can determine a group of entity types that represent only the staff and service-related entities. L2 can determine the user service group. L3 can determine the appointment group. L4 can determine the visit intent (e.g. schedule appointment, request information, add a service, modify a service, etc.). It is noted that other examples can have more or less levels in a DAG frame labeler cascade. The number of levels can be dependent on the desired depth of the DAG frame. Each entity group can have its own level. It is noted that entities that are detected can be added as features to the word vectors by each level's labeler. In this way, a deep multi-level tag can be inferred in the form of structured information from a dialog session.

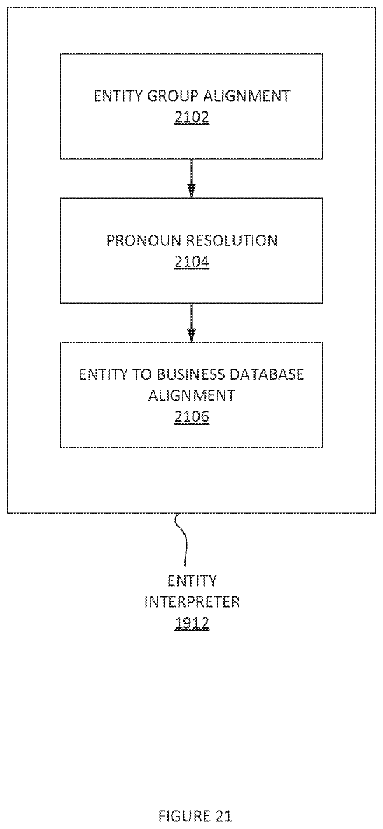

FIG. 21 illustrates an example entity interpreter 1912, according to some embodiments. Entity interpreter 1912 can implement entity group alignment 2102. Entity group alignment 2102 can associate various services with various users from the various messages.

Entity interpreter 1912 can implement pronoun resolution 2104. Entity interpreter 1912 can implement entity to business database alignment 2106. Each phrase in a message is mapped to an entry business menu in the relevant business database. The phrase can be augmented with information from previously used services.

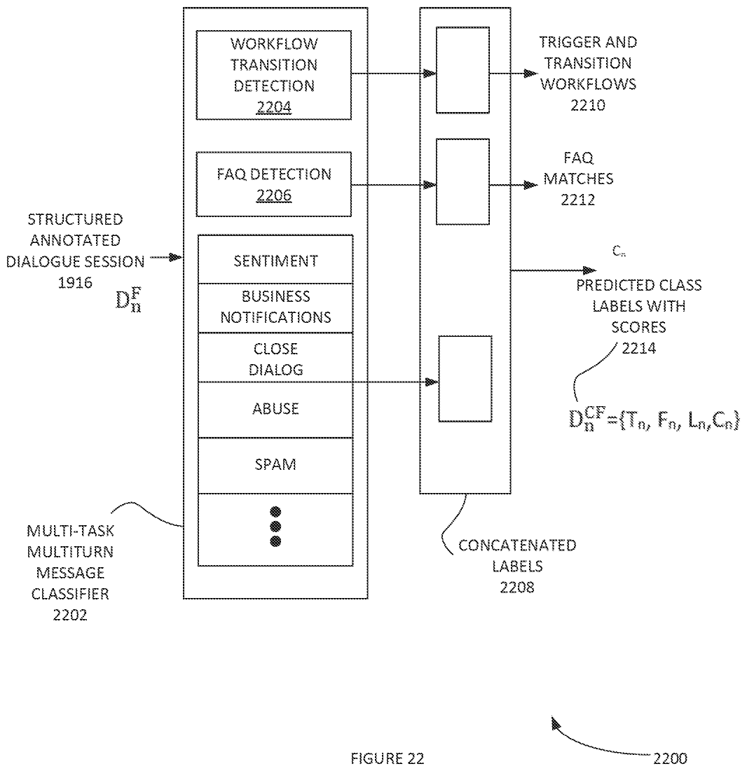

FIG. 22 illustrates an example multitask learning framework 2200 for multi-point communication, according to some embodiments. Multitask learning framework 2200 can receive a DAG frame (e.g. as output by system 1900). Multitask learning framework 2200 can subject the DAG frame to a multi-task layer processing. The multi-task layer processing can infer everything that is needed to suitably respond to the incoming messages received by system 1900. Multitask learning framework 2200 can use multi-task layer processing to predict various class labels. Each prediction comes with a score that is associated with a confidence level. This is in preparation for the messages that can then be constructed in a response. Multitask learning framework 2200 can augment the DAG frame with class labels to enhance the structured annotated dialog session.

More specifically, multitask learning framework 2200 can receive structured information from multiturn dialogue 1916, Dₙ^{F}, of system 1900 with multi-task multiturn message classifier 2202.

Multi-task multiturn message classifier 2202 includes various detectors/filters. These can include workflow transition detection 2204 and FAQ detection 2206. Workflow transition detection 2204 can pass on detected workflow transitions to concatenated labels 2208. Concatenated labels 2208 can then trigger and transition workflows 2210.

FAQ detection 2206 can pass on detected FAQ to concatenated labels 2208. Concatenated labels 2208 can generate FAQ matches 2212.

Concatenated labels 2208 can generate concatenated labels 2208, Cₙ, from transition workflows 2210 and FAQ matches 2212. These can be used to create predicted class labels with scores 2214 by adding Cₙ to Dₙ^{F}. In this way, multi-task multiturn message classifier 2202 generates Dₙ^{CF}={Dn, Tₙ, Lₙ, Fₙ, Cₙ}. Dₙ^{CF}={Dn, Tₙ, Lₙ, Fₙ, Cₙ} can be passed to an AI-based business assistant (see example AI-based business assistant 2300 infra).

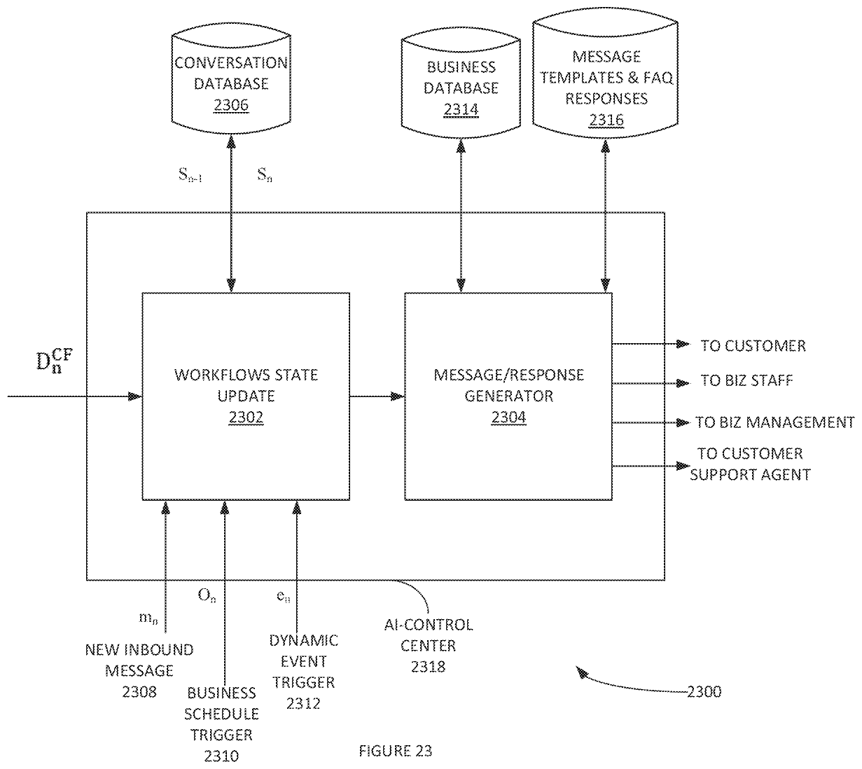

FIG. 23 illustrates an example AI-based business assistant 2300, according to some embodiments. AI-based business assistant 2300 can assume DAG frames with class labels as input. These can be generated, for example, by the systems of FIGS. 19-22. AI-based business assistant 2300 can obtain the predicted structure and implement the MIDGO AI-based business assistant functionality. The MIDGO AI-based business assistant functionality determines how to respond to an incoming message. It is noted that there can be various other triggers besides an incoming message. These can cause AI-based business assistant 2300 to generate a message.

The message can be sent to various entities, such as, inter alia: a customer, an administrator, other business entity/level, etc. At a given instant, the AI-based business assistant 2300 communicates with multiple stakeholders simultaneously, coordinating where necessary to get complete the required task. To this end, it sends messages not only to the customer, but also to the business (potentially at multiple escalation levels, such as staff, manager, etc.). Equally important is how the AI-based business assistant 2300 sends messages to the customer support agent who is live handling that particular customer call, thereby enabling the agent to efficiently and accurately resolve the customer request.

AI-based business assistant 2300 implement a conversation via a plurality of workflows. A workflow can be a linear sequence of interactions. A rich interaction can involve stringing together multiple workflows. A set of FAQs and associated answers can be pulled by AI-based business assistant 2300 and integrated into the interaction as well.

AI-based business assistant 2300 can automatically respond to various inbound messages (e.g. mₙ, etc.). AI-based business assistant 2300 also implements various specified business-related triggers (e.g. at nine a.m. run an appointment confirmation campaign for all appointments that are two days in the future, etc.). A business can also define a business-trigger that depends on a customer attribute. In another example, it would run a business scheduled campaign that reaches out to all customers who have missed a specified service during a specified period. In these, the AI-based customer support agent can automatically construct a message and communicate the message to a specified pool of customers based on one or more pre-specified triggers. AI-based business assistant 2300 can trigger workflow at any given point as well (e.g. based on a dynamic trigger, new incoming message, scheduled business trigger, etc.).

AI-based business assistant 2300 can include an AI-control center 2318. AI-control center 2318 recognizes triggers, events, etc. AI-control center 2318 interacts with a conversation database 2306. Conversation database 2306 includes a history of each conversation thus far. AI-control center 2318 also interacts with business database 2314. Business database 2314 captures and includes information about various business metrics. These can include, inter alia: business inventory, business schedule, business pricing structures, business services, CRM system(s), etc. AI-control center 2318 can use information obtained from the interactions with conversation database 2306 and business database 2314 to generate an output. The output can also be based on the structured information of dialog and the various triggers, AI-control center 2318 can use workflows state update module 2302 to update a workflow state. Sₙ₋₁ can be the state of the conversation at time point, n−1 (e.g. before nth event) that triggers AI-control center 2318. Workflows state update module 2302 can implement a compute and then output an updated state as of time n and store it back into conversation database 2306.

A conversation state can be, inter alia: a list of active workflows, a list of active workflow states, etc. Conversation database 2306 also stores call metadata (e.g. includes caller identifier, reason of call, call location, type of calling device, calling method (e.g. call, text, voice mail, messenger system, etc.). Conversation database 2306 stores a sequence of events and triggers that were part of each session.

More specifically, AI-based business assistant 2300 receives predicted class labels with scores 2214, Dₙ^{CF}={Dn, Tₙ, Lₙ, Fₙ, Cₙ}. In AI-based business assistant 2300, workflows state update module 2302 can receive Dₙ^{CF}={Dn, Tₙ, Lₙ, Fₙ, Cₙ}. Workflows state update module 2302 can also access conversation database 2306. Workflows state update module 2302 can receive new inbound message 2308. New inbound message 2308 can be represented by mₙ. Workflows state update module 2302 can receive business schedule trigger 2310. Business schedule trigger 2310 can be represented by Oₙ. Oₙ can be business scheduled outbound triggers. Workflows state update module 2302 can receive dynamic event trigger 2312. Dynamic event trigger 2312 can be represented by eₙ. eₙ can be dynamic event triggers (e.g. guest has checked in or checked out at a spa, visitor on a website fills out a form requesting more information, etc.). Dynamic event triggers may not be scheduled but can be detected to occur. In one example, an unresponsive user can be a trigger to escalate the user contact session (e.g. a call) with a pass off to a human customer agent.

Using the content of conversation database 2306, mₙ, Oₙ, and eₙ; workflows state update module 2302 can update the state of Dₙ^{CF}. This can be sent to message/response generator 2304. Message/response generator 2304 can use business database 2314 and message templates 2316 to generate a message and/or response. Message/response generator 2304 can obtain various information from business database 2314, such as: business inventory, schedules, FAQs, etc. The workflow in a given state can instruct an action to be taken. Message templates 2316 can include message templates that include message content that enables the action to be taken via a message. For example, a message template can be provided for every message that the AI-based business assistant 2300 can respond with. Message templates 2316 can also include a set of indexed responses to FAQs as well.

Hierarchical Structure Learning with Context Attention from Multi-Turn Natural Language Conversations

Models that are structural, such as sequence labelling, are effective in standard natural language processing applications such as POS or part-of-speech tagging as well as entity extraction. These models are typically organized in shallow structures, one common organization being slot-value pairs. However, in our situation where the data is multi-turn conversations between two parties, a business and a customer, these shallow structures fail to obtain and retain the necessary data. Processes provided herein can use information that is exchanged can be stored in a deeper hierarchy, a directed acyclic graph (e.g. a DAGFrame). This structure is not shallow but rather nested. Processes are provided for extracting structured information from multi-turn conversations and organizing them into these deeper structures. This method has two key innovations. First, labels can percolate from lower levels into higher levels through a feature vector that the information is appended to. Second, an attention mechanism can be introduced that allows the label for any given token to be informed by selected tokens from a context message. The process can use a hierarchical labelling scheme based on bidirectional LSTMs with contextual attention, we demonstrate the benefits of incorporating labels from lower levels in the hierarchy as categorical features for higher level label inference.

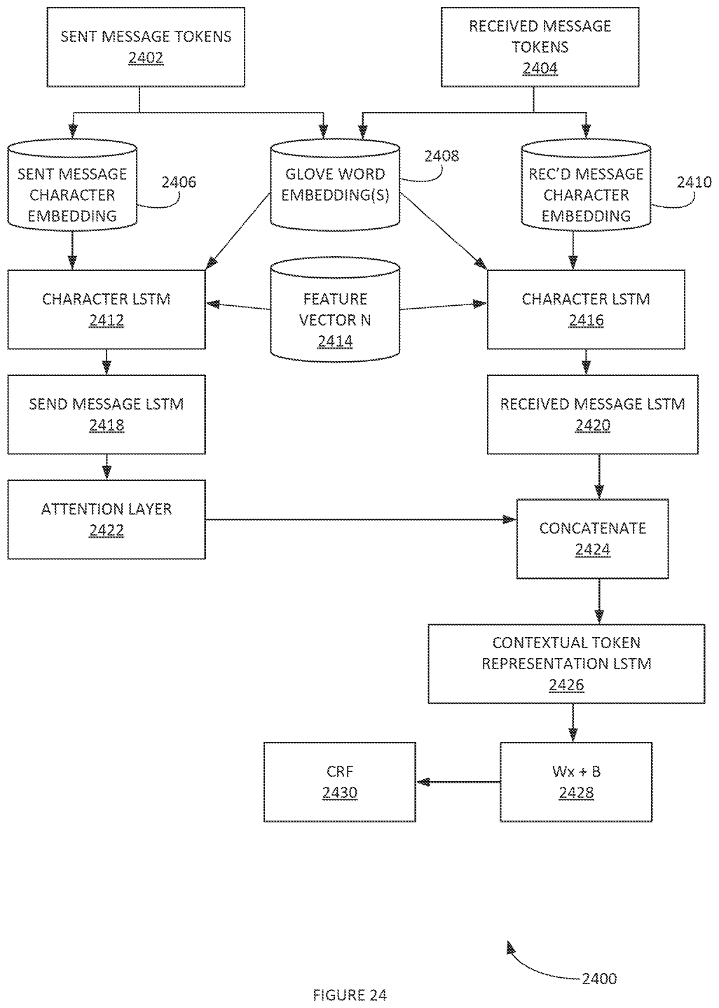

FIG. 24 illustrates an example neural architecture 2400 for hierarchical sequence labelling, according to some embodiments. A hierarchical sequence labeler is included. On the whole, this novel neural architecture can be described as hierarchical, using a multi-pass approach. There are “layers” present in the model, numbered 0 through 4 (e.g. Layers 2602-2610 discussed supra). The addition of these layers, allows for there to be more context in decision-making in areas where standard sequence labelling is ineffective. After the corresponding input sentence is parsed, and embedded into corresponding character and word vectors and passed through the model, the corresponding bits of the feature vector are augmented and this feature vector is used by the next layer of the model, which is the same model now with a new set of labels and an augmented feature vector. Like the DAGFrame, this feature vector is initially empty (all 0s) at Layer 0 (e.g. layer 0 2602, etc.). However, at the end of each layer, more information is added to this feature vector that allows the next layer to have additional context when labelling in the next pass/layer. In addition to the multi-layer procedure to labelling, an attention Layer was added just after the contextual and received message were represented as vectors. These vectors are inputs into the attention layer, albeit at different time steps. This attention layer decides how much “focus” each piece of information in the message representations should get. It works in a manner similar to vision in that some aspects are given high resolution or more attention and the surroundings as a result are given less attention. The attention layer captures contextual information and based on this can reduce the “noise” present in the message representations. The type of attention layer present in this model is the Dot Product type which uses the dot product of the scores matrix and encoder states and its final score. The difference between a Dot Product attention layer and other types such as Additive and Location Base is its alignment function. Finally, a conditional random field (CRF) is applied to the result after passing through the attention layer, is used to infer the label sequence with the highest probability given the message context. The use of DAGFrames in labelling in a layered approach is versatile in that this methodology can be used with any type of model. For this sequence labelling task, a Bidirectional LSTM was chosen, however, models and/or transformers such as BERT and Seq2Seq can be used alongside the DAGFrame infrastructure based on the functionality.

Returning, to process 2400, in step 2402, process 2400 provides sent message tokens. In step 2404, process 2400 provides received message tokens. These can be passed and stored in sent message character embedding 2406, glove word embedding(s) 2408 and received message character embedding 2410.

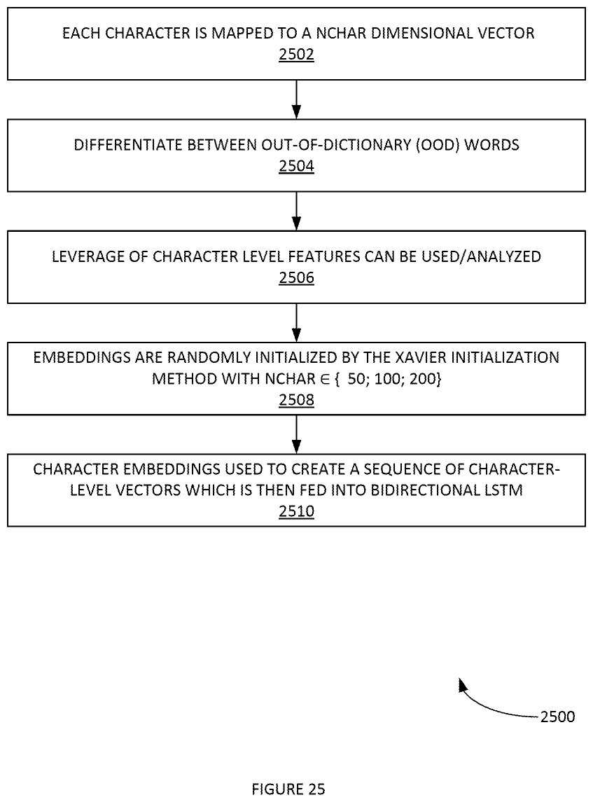

Character embeddings are now discussed. FIG. 25 illustrates an example architecture 2500 for the character-level embeddings for the sent message, according to some embodiments. In step 2502, each character is mapped to a nchar dimensional vector. This allows the model to be able to implement the following.

In step 2504, the model can differentiate between out-of-dictionary (OOD) words. For example, using the following root sentence: I want [symbol] OOD [symbol] . The OOD tag could be replaced by words from any class. An example can be: “I want color′n′cut I want Adalice I want tomorrow”. It is noted that if process 2500 (and/or process 2400) were to forego the usage of character embeddings, the remaining ‘ow’ may not have the requisite information to label each of these words distinctly as the context remains identical.

In step 2506, the leverage of character level features can be used/analyzed. This can include the presence of capital letters which often provide information with regards to names (e.g. of people and services). In step 2508, the embeddings are randomly initialized by the Xavier initialization method with nchar E {50; 100; 200}. In step 2510, the character embeddings are used to create a sequence of character-level vectors (e.g. a word) which is then fed into a Bidirectional LSTM. The final output vectors from each (e.g. of the forward and backward LSTM) can then concatenated and form the morphological word vector, wchar as well. It is noted the FIG. 25 of United States Provisional Application. No. 63246317 (which is incorporated herein by reference) includes additional information for implementing process 2500.

Sent message character embedding 2406, GloVe (Global Vectors) word embedding(s) 2408 and feature vector n 2414 are used for generating character LSTM in step 2412. Received message character embedding 2408, GloVe word embedding(s) 2408 and feature vector n 2414 are used for generating character LSTM in step 2416. Character LSTM in step 2412 is used to provide a send message LSTM in step 2418. Character LSTM in step 2416 is used to provide a received message LSTM in step 2420. An attention layer is implemented in step 2422. The output of attention layer 2422 is then concatenated with output of step 2416 in step 2424. In step 2426, process 2400 implements a contextual token representation LSTM. In step 2428, process 2400 implements a Wx+B. This can be globally initialized. In step 2430, a CRF is applied to the result after passing through the attention layer, is used to infer the label sequence with the highest probability given the message context.

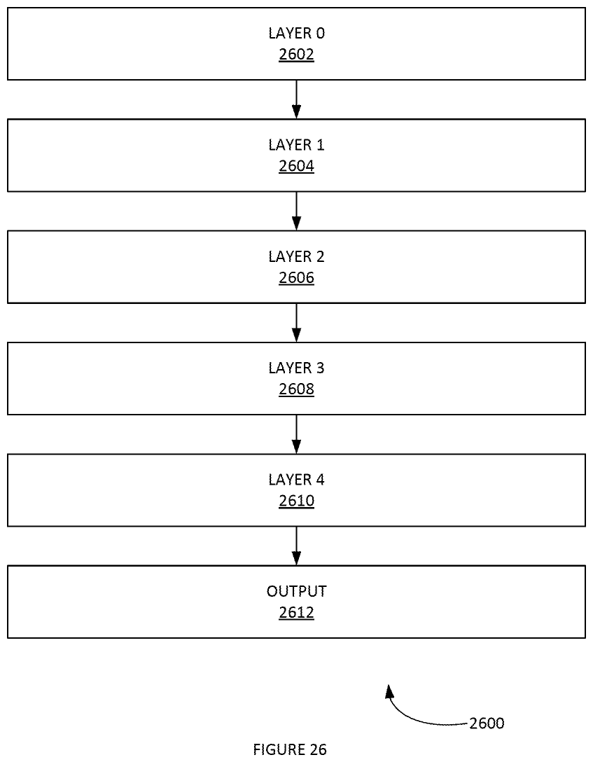

FIG. 26 illustrates an example architecture 2600 used herein, according to some embodiments. In layer 0 2602, a contextual attention-based model LSTM unit can be implemented. The input message can be n tokens. An augmented vector represented can be used with GloVe embeddings and character LSTM. The feature vector at layer 0 2602 can be updated and concatenate with the output of CHAR LSTM and GloVe embeddings. This can be same processes that applies for higher layers/levels. Layer 1 2604 can implement a contextual attention-based model unit. The feature vector can be augmented and layer 1 2604 labels can be inputted into the next unit. Layer 2 2606 can implement a contextual attention-based model unit. A feature vector is augmented. Layer 2 2606 labels inputted into the next unit layer 3 contextual attention-based model unit. Layer 3 2608 labels inputted into the next unit and the feature vector is augmented. Layer 4 2610 can implement a contextual attention-based model unit. The output 2612 can be list of labelled tokens for all four layers 2604-2608.

Appendix A of United States Provisional Application. No. 63246317 (which is incorporated herein by reference) illustrates two example DAG frames, according to some embodiments. A completed, hand-drawn diagram of a DAGFrame at the end of a conversation is shown therein. As stated previously, the DAGFrame can be initially empty, and as context is gathered, we can see the information being filled in. The significant part of this schema is the configuration attribute. The labeler allows for the selection of a particular configuration based on context such that the best possible set of labels is used for a particular grouping. In this example, the configuration three is chosen, consisting of a location, time, service, and client list. In times where in the conversation, there are multiple bookings with multiple services, the configuration can change or multiple configurations can be chosen to accommodate that.

A conversation is a set of dialogs, where each dialog consists of 2 turns, one user message to be labelled and one context message. For each conversation, user, service, and other labels are chosen for each token of the s. The full list of Labels is None, Biz.LOC, Appt.TIME, Appt.USRCNT, Service.TYPE, State.NAME, User.Name, Service.REF, State.REF, and User.REF. The DAGFrameLabeller takes in a conversation and returns its output, a set of labels, in an XML file with the tag session. An example schema in XML form for this semantic DAGFrame is shown in FIG. 6 supra.

Raw word vectors are now discussed. The character level word vector captures the morphological context of the word. However, this alone may be insufficient. A semantic understanding of the word is also required. Process 2400 can leverage the pre-trained 8 glove word embeddings. These two vectors capture distinct characteristics of the word and are concatenated before being sent to the word level Bi-directional LSTM to incorporate the context of the sentence.

Word Level Bi-directional LSTM is now discussed. The input to this word level LSTM cell is the concatenation of the raw word vector found through the output of the character-level BiLSTM, with the glove word embedding and the feature vector. The sequence of words which constitute a sentence are then fed into a bi-directional LSTM. Recall that in the case of the character level bi-directional LSTM, Process 2400 can concatenate the final output of the forward and backward pass for our final output. If we were to do something similar here, we would obtain a vector representing the message. However, what we require is a contextualized word vector (e.g., one that takes into account the other words in the message). In order to do this, for each word w, we concatenate the hidden vector corresponding to the forward and backward pass to obtain a vector, wcontext.

Contextual Word Vector is now discussed. The message m=(w1; :::;wk) is thus converted into a sequence of word vectors s=(wcontext 1; :::;wcontext k). Each of these word vectors holds a contextual representation of the word with respect to the entire message.

The attention layer is now discussed. The attention layer is used to mimic cognitive attention, where certain pieces of information, or certain data points are given more recognition and therefore weight. In this implementation, the attention layer gives more importance to words that hold more context. The input is the output of the sent message (word-level) BiLSTM with the received message (word-level) BiLSTM. The output is a vector that serves as input into the Contextual Token Representation layer of the model. The architecture of the attention layer is shown below.

The first part of the attention layer is a fully connected, dense layer that takes in encoder output and outputs a score that will be passed into a SoftMax function that will turn the scores into probabilistic estimates. A dot product will then be taken between these estimates and the encoder states. This output is then prepended to the received message word representation and serves as the input to the Contextual Token Representation layer. This process is repeated for each token of the received message to label, such that in the end, there is a vector prepended to every received message vector that indicates how much attention to place on each token of the context message for each token of the received message. In short, every received message token, by the end of this process, will have a set of weights that will correspond to the attention to place on the corresponding context message token.

Contextual Token Representation is now discussed. The output of the attention layer along with the output of the received message BiLSTM is fed into this Contextual Token Representation BiLSTM. The output from this BiLSTM is then reshaped and put through a Dense Layer before being fed into CRF.

### Example Results

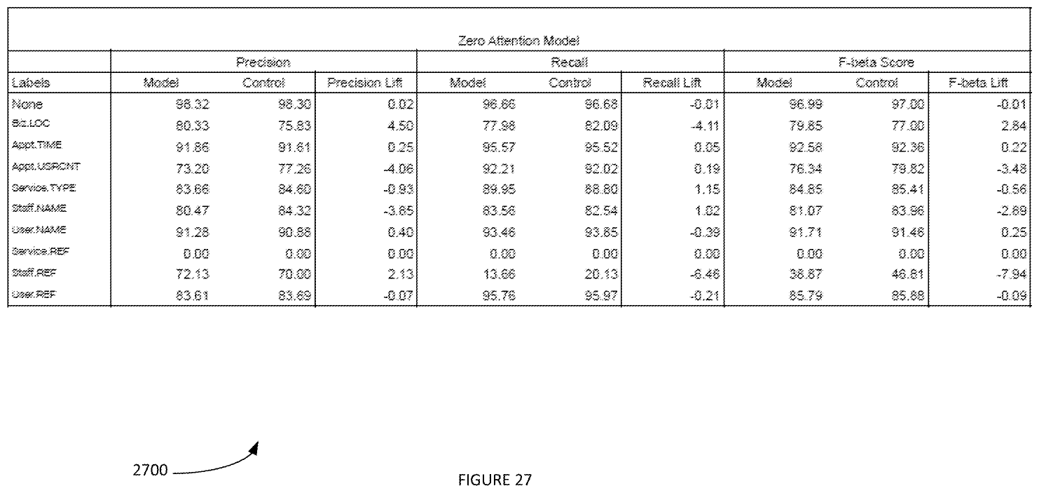

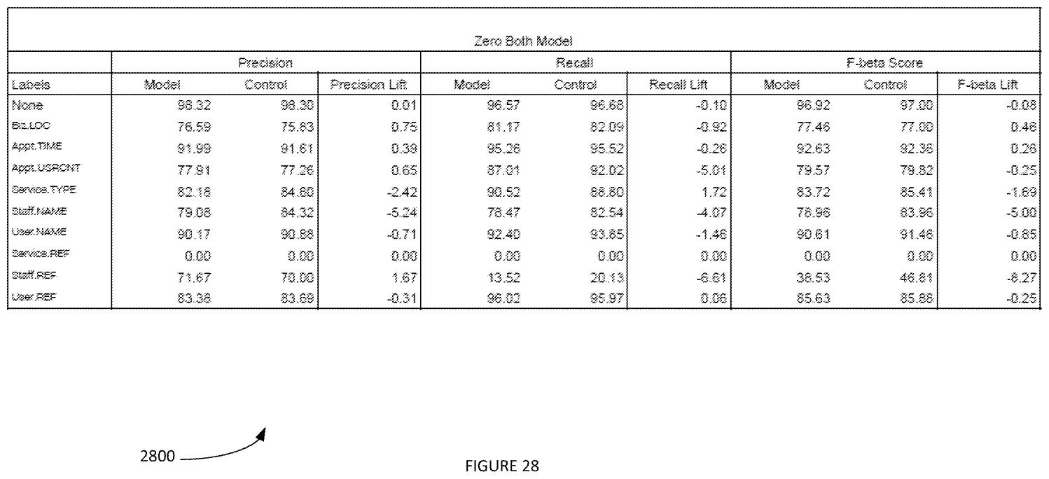

FIGS. 27-29 illustrates tables 2700-2900 provided example results, according to some embodiments. As shown in tables 2700-2900, demonstrate the utility of a DAGFrame labeler in two steps. Tables 2700-2900 how the attention layer is used for high precision and recall (e.g. F-beta score). Tables 2700-2900 show propagating the labels from the previous layer is critical to successful hierarchical labelling.

FIGS. 27-29 illustrate the performance of the model with both the attention layer and the augmented feature vector present. When the attention layer is removed, the outputs of the received message interpretation and contextual message representation can be concatenated. The result can be input into the contextual token representation layer. When the attention layer is removed, the precision, recall, and F-beta scores along with their respective lifts can be determined and compared to a model which contains both the augmented feature vector and the attention layer for each label type. These metrics are shown in table 2700. Table 2700 has rows with a first element corresponds to a given label. In the first column, table 2700 provides the precision differences, by comparing the model in which the attention layer is removed. The control can be the full architecture described supra. In this way, the precision lift can be observed and/or a change in precision for a certain label between the model without the attention layer and the control can be implemented. It is noted that this same format can be applied to recall with the recall lift equal to the difference between the recall of that token by the model without the attention layer and the control.

The F-beta score which values precision twice as much as recall is also calculated and its respective values for each token and their lifts are calculated. The next experiment can compare the performance of the model provided supra in FIG. 24 to a model without the presence of the augmented feature vector. This can be done by setting each value of the feature vector to 0 each time. This can remove some context from the labelling of previous layers. The resulting metrics after running the feature vector free model, are shown below in FIG. 27.

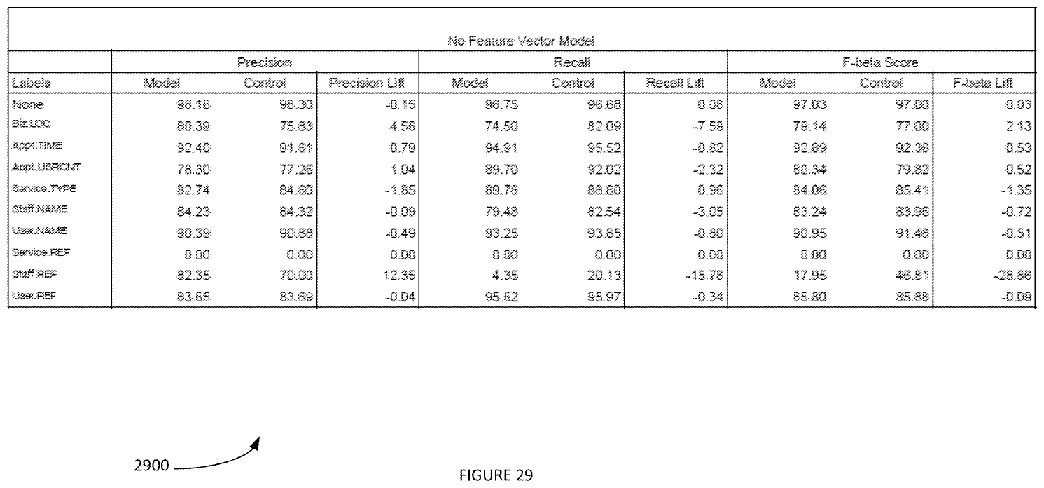

As shown, even without the presence of a feature vector, the model can be accurate in determining when not to label a token, as well as labelling appointment times and the names of users. Without a feature vector, staff and service references may not be accurately classified, with low precision and recall scores, indicating that it not only was the model poor in retrieving those labels, but also poor in finding the instances of staff and service references with the removal of the feature vector. The model can be trained without the presence of both the augmented feature vector and attention layer. The resulting scores are shown in FIG. 29.

From some example experiments, the presence of the feature vector and attention layer lowers performance in Biz.LOC and Appt.TIME, but improves performance in Service.TYPE, Staff.NAME, User.NAME, Staff.REF, and User.REF. This change may be magnified with the absence/presence of both aspects. Computing the F-Beta scores with precision values may provide twice as much as recall. Without both feature vectors and the attention layer the F-beta score may be improved versus the model with both, in only the Biz.LOC and APPT.TIME. For the model without the feature vector but with the attention layer, the F-Beta scores may be improved on Biz.LOC, Appt.TIME, Appt.USRCNT but may deteriorate in areas User.Name, Service.Type, Staff.Name, User.Ref and Staff.Ref.

For the model with the attention layer present but without feature vectors, the improvements versus the model with both in areas such as User.NAME, Biz.LOC and Appt.TIME are shown. However this model worsens in areas such as service type and Staff.NAME. Thus, the presence of the augmented feature vector improves performance in finding name entities while the attention layer improves presence in APPT.USRCNT and None. FIGS. 27-29 are provided by way of example and not of limitation.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method for implementing a neural architecture for hierarchical sequence labelling comprising:
obtaining a tokenized input message comprising a set of sent message tokens and a set of received message tokens;
with the neural architecture:
inputting the set of sent message tokens, wherein the set of sent message tokens are passed and stored in a sent message character embedding and a GloVe (Global Vectors) word embedding;
inputting the set of received message tokens, wherein the set of received message tokens are passed and stored in a received message character embedding, and the GloVe word embedding;
providing a feature vector;
using the sent message character embedding, the GloVe word embedding, and the feature vector to generate a first character LSTM;
using the received message character embedding, the glove word embedding and the feature vector to generate a second character LSTM;
using the first character LSTM to generate a send message LSTM;
using the second character LSTM to generate a received message LSTM;
providing the send message LSTM to an attention layer, and the attention output of the attention layer is concatenated with the received message LSTM;
from the concatenated output of the attention layer and the received message LSTM, generating a contextual token representation LSTM;
implementing a Wx+B function on the contextual token representation LSTM;
applying a Conditional random fields (CRF) method to the output of the Wx+B function; and
using the CRF output to infer a label sequence with a highest probability given a message context of the tokenized input message.

2. The computerized method of claim 1, wherein the neural architecture is a hierarchical neural architecture.

3. The computerized method of claim 2, wherein the neural architecture uses a multi-pass approach.

4. The computerized method of claim 3, wherein the attention layer:
captures a contextual information and uses the contextual information reduce any noise present in the message representations.

5. The computerized method of claim 3, wherein the attention layer comprises a dot product type that uses a dot product of a scores matrix and an encoder state to generate a final score, and wherein a difference between a dot product attention layer and an additive and location base comprises an alignment function.

6. The method of claim 1, wherein the neural architecture is implemented by a hierarchical sequence labeler.

7. The computerized method of claim 1, wherein the tokenized message is derived from a voice messages, a text messages, or a conversation dialog text with a chat bot.

8. The computerized method of claim 1, wherein the Wx+B is globally initialized.

9. The computerized method of claim 1, wherein each character of the sent message character embedding and the received message character embedding is mapped to a nchar dimensional vector.

10. The computerized method of claim 9 further comprising:
differentiating between each out-of-dictionary (OOD) word; and
determining a leverage of all the character level features.

11. The computerized method of claim 10 further comprising:
randomly initializing the character embeddings with a Xavier initialization method; and
with the character embeddings, creating a sequence of character-level vectors.

12. The computerized method of claim 10 further comprising:
feeding the sequence of character-level vectors into a Bidirectional LSTM, wherein the final output vectors from each character are concatenated and form a morphological word vector.

13. A computerized method for implementing a neural architecture for hierarchical sequence labelling comprising:
providing a neural architecture comprising a set of labelling layers, wherein the neural architecture uses a multi-pass approach on the set of labelling layers,
receiving an input sentence;
parsing the input sentence;
embedding the input sentence into a corresponding character vector and a corresponding word vector to generate a feature vector;
passing the feature vector through the neural architecture; and
performing a multi-layer labelling procedure on the feature vector with the neural architecture comprising:
augmenting a set of corresponding bits of the feature vector, wherein the feature vector is passed through the set of labelling layers of neural architecture, wherein each subsequent layer of the neural architecture comprises a same neural architecture with a new set of labels and produces an augmented version of the feature vector, wherein the feature vector is initially empty at a first layer of the set of labelling layers, wherein at the end of each layer of the set of labelling layers additional information is added to the feature vector such that each subsequent layer has an additional context when a labelling action is performed during a subsequent layer.

14. The computerized method of claim 13 further comprising:
providing an attention layer of the neural architecture, wherein the attention layer:
receives a received message represented as a vector at a different time step;
determines a focus of each piece of information in the received message; and
captures a contextual information of the received message and based on the contextual information reducing a noise present in one or more message representations.

15. The computerized method of claim 14,
wherein the attention layer in the neural architecture comprises a dot product type which uses a dot product of a scores matrix and a set of encoder states to calculate a final score, and
wherein the received message comprises a contextual message and a received message.

16. The computerized method of claim 15, further comprising:
with the neural architecture:
applying a conditional random field (CRF) to an output of the attention layer to infer a label sequence with a highest probability given the message context.

17. The computerized method of claim 16, further comprising:
using of one or more DAGFrames for layer-based labelling.

18. The computerized method of claim 17, wherein in a Bidirectional LSTM is used for sequence labelling by the neural architecture.

19. The computerized method of claim 17, wherein in a BERT or Seq2Seq is used with the DAGFrame by the neural architecture.

20. The computerized method of claim 17, wherein the set of labelling layers present in the neural architecture are numbered 0 through 4.
